(19) United States
(12) Patent Application Publication
(10) Pub. No.: US 2020/0407525 A1
(43) Pub. Date: Dec. 31, 2020

(54) Porous Polymer Membranes Comprising Vertically Aligned Carbon Nanotubes, and Methods of Making and Using Same

(71) Applicants: Rutgers, the State University of New Jersey, New Brunswick, NJ (US); Chasm Technologies Inc., Canton, MA (US); Lawrence Livermore National Security, LLC, Livermore, CA (US)

(72) Inventors: Jerry Shan, Piscataway, NJ (US); Richard Castellano, Piscataway, NJ (US); Robert F. Praino, Jr., Canton, MA (US); Francesco Fornasiero, Livermore, CA (US); Julie Anne Praino, Waltham, MA (US)

(21) Appl. No.: 16/767,507

(22) PCT Filed: Nov. 27, 2018
(86) PCT No.: PCT/US2018/062587

§ 371 Date: May 27, 2020

Related U.S. Application Data
(60) Provisional application No. 62/590,984, filed on Nov. 27, 2017.

(51) Int. Cl. C08J 5/24; C01B 32/174; C08J 5/00; B01D 69/14; B01D 71/02; B01D 71/54; B01D 71/70; B01D 67/00; B01D 69/12

(52) U.S. Cl. CPC C08J 5/24; B01D 2323/35; C08J 5/005; B01D 69/148; B01D 71/021; B01D 71/54; B01D 71/70; B01D 67/0006; B01D 67/0032; B01D 67/0079; B01D 69/125; C01B 2202/08; C01B 2202/34; C01B 2202/36; C08J 2375/14; C08J 2383/04; C01B 32/174

(57) ABSTRACT

The present invention provides in one aspect inexpensive and scalable methods of fabricating porous membranes comprising vertically aligned carbon nanotubes.

### CROSS-REFERENCE TO RELATED APPLICATIONS

The present application is a 35 U.S.C. § 371 national phase application from, and claims priority to, International Application No. PCT/US2018/062587, filed Nov. 27, 2018, published under PCT Article 21(2) in English, which claims priority under 35 U.S.C. § 119(e) to U.S. Provisional Application No. 62/590,984, filed Nov. 27, 2017, all of which applications are incorporated herein by reference in their entireties.

### STATEMENT REGARDING FEDERALLY SPONSORED RESEARCH OR DEVELOPMENT

This invention was made with government support under grant number BA12PHM123 awarded by The Defense Threat Reduction Agency. The government has certain rights in the invention.

### BACKGROUND OF THE INVENTION

In order to fully benefit from the unique mechanical, electronic, and transport properties of carbon nanotubes (CNTs), many applications require macroscopic samples of well-organized CNT architectures, such as vertically aligned carbon nanotube (VACNT) arrays, CNT sheets, or CNT ropes. In particular, for fluid-transport applications, membranes having VACNTs as through-pores have flow rates that are three-to-five orders of magnitude higher than expected by Poiseuille or Knudsen flow theory. Such VACNT membranes also exhibit selective permeability for gas and liquid mixtures, making them attractive for applications that demand high mass flux and species selectivity. Beyond filtration and gas-separation applications, VACNT composites also have utility as thermal-interface materials for the thermal management of electronic devices, or as novel dry adhesives that mimic gecko feet, among numerous other applications.

Many of these potential applications require large-area VACNT composites. Chemical vapor deposition (CVD), which is the dominant synthesis method to produce bulk CNT powders, can also be used to fabricate VACNT arrays. Typical nanotube number densities of order 10¹¹-10¹³ CNTs/cm² can be produced by CVD growth, depending on the nanotube size. However, the growth of high quality, small-diameter, VACNT arrays by CVD is costly and difficult to scale-up to large areas, which has delayed the commercial utilization of VACNT membranes and composites. Therefore, alternative, post-growth CNT-alignment methods are needed to efficiently fabricate large-area VACNT nanocomposites.

Thus, there is a need in the art for inexpensive and scalable methods of fabricating porous membranes comprising vertically aligned carbon nanotubes. The present invention meets and addresses these needs.

### BRIEF SUMMARY OF THE INVENTION

The invention provides certain methods of fabricating a porous polymer membrane. The invention further provides a polymer membrane, which can comprise one or more independently selected layers. In certain embodiments, the polymer membrane is at least partially prepared according to certain methods disclosed herein.

In certain embodiments, the membrane comprises at least one layer. In other embodiments, the membrane comprises more than one layer, wherein the composition of each layer is independently selected. In yet other embodiments, the membrane comprises embedded aligned carbon nanotubes in at least one layer thereof. In yet other embodiments, the aligned carbon nanotubes, each having an unobstructed lumen, extend through the polymer membrane layer in which they are contained, such that the lumen of the aligned carbon nanotubes define a pore extending through the polymer membrane layer.

In certain embodiments, the method comprises (a) contacting a polymer precursor suspension, comprising nanotube bundles suspended therein, with a substrate surface. In other embodiments, the method comprises (b) electrodepositing the nanotube bundles onto the substrate surface, such that the nanotube bundles are aligned perpendicular to the substrate surface. In yet other embodiments, the method comprises (c) curing the polymer precursor suspension, thereby forming a polymer membrane comprising embedded nanotube bundles. In yet other embodiments, the method comprises (e) removing the polymer membrane from the substrate and etching the polymer membrane surface(s) to expose the ends of the embedded nanotube bundles. In yet other embodiments, the method comprises repeating steps (a)-(c) [or (a)-(c) and (e)] at least one time, so as to generate a multilayer polymer membrane, wherein the nanotube bundles and polymer precursor suspension used in each repetition are independently selected. In yet other embodiments, etching takes place once the multilayer membrane is formed. In yet other embodiments, etching can take place after one or more intermediate layers of the multilayer membrane is formed. In yet other embodiments, etching can take place after each intermediate layer of the multilayer membrane is formed.

In certain embodiments, the method comprises (a) contacting a first solution suspension, comprising nanotubes suspended therein, with a substrate surface. In other embodiments, the method comprises (b) electrodepositing the nanotube bundles onto the substrate surface, such that the nanotube bundles are aligned perpendicular to the substrate surface. In yet other embodiments, the method comprises (c) optionally flowing a second solution not comprising suspended nanotubes over the substrate surface in order to remove any nanotubes that have not been electrodeposited onto the substrate surface. In yet other embodiments, the method comprises (d) flowing a polymer precursor over the substrate surface, displacing any solution in contact with the aligned nanotube bundles. In yet other embodiments, the method comprises (e) curing the polymer precursor thereby, forming a polymer membrane comprising embedded nanotubes. In yet other embodiments, the method comprises (g) removing the polymer membrane from the substrate and etching the polymer membrane surface(s) to expose the embedded carbon nanotubes. In other embodiments, the method comprises repeating steps (a)-(e) [or (a)-(e) and (g)], wherein step (c) is optional, at least one time, so as to generate a multilayer polymer membrane, wherein the nanotubes and polymer precursor suspension used in each repetition are independently selected. In yet other embodiments, etching takes place once the multilayer membrane is formed. In yet other embodiments, etching can take place after one or more intermediate layers of the multilayer membrane is formed. In yet other embodiments, etching can take place after each intermediate layer of the multilayer membrane is formed.

In certain embodiments, the method comprises (a) contacting a polymer precursor suspension, comprising nanotube bundles suspended therein, with a substrate surface, wherein the substrate is transparent to at least one wavelength of light from a light source. In other embodiments, the method comprises (b) electrodepositing the nanotube bundles onto the substrate surface, such that the nanotube bundles are aligned perpendicular to the substrate surface. In yet other embodiments, the method comprises (c) photocuring the polymer precursor suspension by exposing the polymer precursor to the light source through the transparent electrode, such that the polymer precursor suspension is selectively cured up to the extinction length of the light source wavelength within the polymer precursor medium, thereby forming a polymer membrane comprising embedded nanotubes. In yet other embodiments, the method comprises (e) removing the polymer membrane from the substrate and etching the polymer membrane surface(s) to expose the ends of the embedded nanotubes. In yet other embodiments, the method comprises repeating steps (a)-(c) [or (a)-(c) and (e)] at least one time, so as to generate a multilayer polymer membrane, wherein the nanotube bundles and polymer precursor suspension used in each repetition are independently selected. In yet other embodiments, etching takes place once the multilayer membrane is formed. In yet other embodiments, etching can take place after one or more intermediate layers of the multilayer membrane is formed. In yet other embodiments, etching can take place after each intermediate layer of the multilayer membrane is formed.

In certain embodiments, the nanotubes or nanotube bundles comprise carbon nanotubes. In other embodiments, the nanotubes or nanotube bundles comprise single walled nanotubes, double wall nanotubes, or any mixtures thereof. In yet other embodiments, the nanotubes or nanotube bundles comprise uncapped nanotubes, having an at least partially unblocked lumen throughout the length of each nanotube. In yet other embodiments, the nanotubes or nanotube bundles comprise nanotubes functionalized with at least one functional groups that promotes bundling. In yet other embodiments, the nanotube bundles comprise nanotubes functionalized with at least one functional group selected from the group consisting of amine, alkyl amine, carboxyl, phenolic, lactone, and hydroxyl. In yet other embodiments, the nanotubes or nanotube bundles have a length of about 1 μm to about 200 μm. In yet other embodiments, the nanotubes or nanotube bundles have a length of about 5 μm to about 15 μm. In yet other embodiments, the nanotubes or nanotube bundles have a diameter of about 0.5 nm to about 150 nm.

In certain embodiments, the polymer precursor comprises at least one monomer selected from the group consisting of aromatic urethanes, aliphatic urethanes, urethane acrylates, silicones, and multifunctional aromatic compounds. In other embodiments, the polymer precursor comprises at least one polymerization initiator. In yet other embodiments, the substrate is an electrode. In yet other embodiments, the electrode comprises at least one material selected from the group consisting of metals, metal oxides, and conductive polymers. In yet other embodiments, at least a portion of the electrode comprises a material transparent to at least one wavelengths in the ultraviolet light (10-400 nm), visible light (400-750 nm), and/or infrared light (750 nm-2,000 nm) ranges. In yet other embodiments, the substrate is a material layer disposed on the surface of an electrode such that the nanotubes or nanotube bundles electrodeposit on the substrate surface distal to the electrode. In yet other embodiments, the substrate comprises a material transparent to at least one wavelength in the ultraviolet light (10-400 nm), visible light (400-750 nm), and/or infrared light (750 nm-2,000 nm) ranges. In yet other embodiments, the substrate comprises at least one material selected from the group consisting of polyethylene, silicone, cyclic olefin polymer, and polymethyl methacrylate.

In certain embodiments, the electrodeposition occurs through the application of both an AC electric field and a DC electric field offset to the electrode. In other embodiments, the electrodeposition utilizes an AC electric field voltage of about 80 Vᵣₘₛ/mm to about 200 Vᵣₘₛ/mm. In yet other embodiments, the electrodeposition utilizes an AC electric field voltage of about 87.5 Vᵣₘₛ/mm to about 175 Vᵣₘₛ/mm. In yet other embodiments, the electrodeposition utilizes a DC electric field offset of about 0 V to about −2.5 V. In yet other embodiments, the electrodeposition utilizes a DC electric field offset of about −1 V to about −2 V. In yet other embodiments, the electrodeposition utilizes an electric field as defined in by the equation:

$${E}_{AC} ( t ) \text{/} \frac{V}{mm} = \{ \begin{matrix}( 175 - 87.5 \frac{t}{150} ) \sqrt{2} sin 20 π t , t < 150 s \\ 87.5 \sqrt{2} sin 20 πt , t \geq 150 s\end{matrix} \\ {E}_{DC} ( t ) \text{/} V = - 2.5 \frac{t}{300} ,$$

wherein (t) is time.

In certain embodiments, the polymer precursor is cured through photocuring. In other embodiments, the polymer precursor is photocured through use of at least one photoinitiator. In yet other embodiments, the polymer precursor is photocured through exposure to at least one wavelength of light in the ultraviolet light (10-400 nm), visible light (400-750 nm) and/or infrared light (750 nm-2,000 nm) ranges. In yet other embodiments, the polymer precursor is photocured through exposure to ultraviolet light having a wavelength of about 230 nm to about 300 nm. In yet other embodiments, the polymer precursor is photocured through the use of laser light and/or light from an LED. In yet other embodiments, the electrode comprises a transparent material and wherein the polymer precursor suspension is selectively cured through exposure to a light source through the substrate, wherein the polymer precursor is cured only up to the extinction length of the light source wavelength within the polymer precursor medium.

In certain embodiments, the polymer precursor is heat cured and/or chemically cured. In other embodiments, the polymer membrane is etched through the use of reactive-ion etching. In yet other embodiments, the polymer membrane is etched through the use of at least one plasma source selected from the group consisting of O₂, H₂O, N₂, SF₆, air plasma, and CF₄. In yet other embodiments, the polymer membrane is etched through the use of O₂-plasma at a power of about 50 W to about 250 W, or about 100 W to about 225 W. In yet other embodiments, the polymer membrane is etched through electrochemical etching. In yet other embodiments, the polymer membrane is electrochemically etched through the use of a layer of sputtered gold. In yet other embodiments, the polymer membrane is electrochemically etched with an applied voltage of about 2.5 V to about 3.5 V. In yet other embodiments, the resulting polymer membrane has a thickness ranging from about 1 μm to about 10 μm.

In certain embodiments, the nanotubes are at least partially agglomerated in nanotube bundles. In other embodiments, at least one from the group consisting of the first solution and the second solution comprises an organic solvent. In yet other embodiments, the first and second solutions comprise solvents that do not dissolve carbon nanotubes and/or do not decay carbon nanotubes. In yet other embodiments, the first and second solution each comprises at least one solvent independently selected from the group consisting of 1-cyclohexyl-2-pyrrolidinone, acetone, dichloromethane, ethanol, isopropanol, hexanes, dichloroethane, dichlorobenzene and dimethylformamide.

### BRIEF DESCRIPTION OF THE DRAWINGS

The following detailed description of specific embodiments of the invention will be better understood when read in conjunction with the appended drawings. For the purpose of illustrating the invention, specific embodiments are shown in the drawings. It should be understood, however, that the invention is not limited to the precise arrangements and instrumentalities of the embodiments shown in the drawings.

FIG. 1A illustrates an SEM image of ethylene diamine (EDA)-treated few-walled nanotube (FWNT) bundles in polymer solution.

FIG. 1B illustrates an SEM image of the top surface of a VACNT membrane created with FWNT bundles.

FIG. 1C illustrates a graph of expected helium-nitrogen (Q_{N2}/Q_{He}) flowrate ratios as a function of pore size. For flow through nanometer-diameter CNTs, the flowrate ratio is expected to be 2.65.

FIG. 1D illustrates a map of flowrate ratios and N₂ permeances expected for different regimes. If data lies close to the target region or partially open membrane region—top right and top left respectively—this is strong evidence of flow through CNT-through-pore without defects.

FIGS. 1E-1F illustrate graphs of transport data on FWNT membranes etched at 50 W with O₂-plasma. FIG. 1E illustrates a graph showing N₂—KCl transport data that lies outside of the expected region. FIG. 1F illustrates a graph of He—N₂ flowrate showing data that lies well away from the target (yellow and green) region.

FIGS. 1G-1H illustrate graphs of transport data on FWNT membranes etched at 100 W with O₂-plasma. FIG. 1G illustrates a N₂—KCl transport graph, with labels also giving the associated He—N₂ flowrate ratios. FIG. 1H illustrates a He—N₂ flowrate graph showing 5 membranes falling in the target region (yellow line/top left hand side of graph) for flow through nanoscale pores without defects.

FIG. 1I illustrates a He—N₂ flowrate graph for FWNT membranes etched at 225 W with O₂-plasma.

FIGS. 1J-1K illustrate graphs of transport data on FWNT membranes treated with electrochemical etching. FIG. 1J illustrates N₂—KCl transport, and FIG. 1K illustrates He—N₂ flowrate.

FIGS. 2A-2B illustrate a schematic of two-step electrodeposition, comprising a first step wherein CNTs are deposited in a solvent phase (FIG. 2A), and a second step wherein polymer is infiltrated into the setup and selectively cured to form a VACNT membrane (FIG. 2B).

FIGS. 3A-3C illustrate optical images illustrating results of the two-step electrodeposition. FIG. 3A illustrates an image of the electrode surface after electrodeposition of CNTs from CHP. FIG. 3B illustrates an image showing that as the polymer solution is injected, a discrete interface is formed between the CHP and polymer. FIG. 3C illustrates an image showing that, after the interface (consisting of flocculated CNTs) moved across the electrode surface, many deposited CNTs had been wiped off.

FIGS. 4A-4C illustrate a scheme of an improved two-step electrodeposition scheme showing that CNTs are deposited in a solvent phase (FIG. 4A), fresh solvent is then used to remove unbound CNTs from the setup (FIG. 4B), and then the polymer is infiltrated into the setup and selectively cured (FIG. 4C).

FIG. 5 illustrates an optical image of a membrane formed by two-step electrodeposition from CHP and subsequent polymer infiltration. The membrane was UV cured and detached from electrode for this image.

FIG. 6 illustrates an image of a microfluidic chamber with transparent electrodes used for visualization of solvent-phase deposition and laser curing of membranes.

FIGS. 7A-7B illustrate SEM images of SA MWNT membranes created according to a solvent-deposition method of the invention. FIG. 7A illustrates a slice of a membrane, while FIG. 7B illustrates a membrane surface exhibiting high CNT density.

FIGS. 8A-8B illustrate schematic representations of the effect of differences in laser-curing angles. FIG. 8A illustrates a scheme showing curing with a prism causing the laser beam to refract at a high angle of incidence, hitting the polymer at a slight angle. FIG. 8B illustrates that curing without a prism can steer the beam at a more direct angle into the polymer. This allows for a much deeper cure thickness. FIGS. 8C-8F illustrate a non-limiting step by step process for the selective curing process. The carbon nanotube solution is first placed between transparent electrodes (FIG. 8C). The electric field is then used to align the nanotubes and the electrophoretic concentration increases (FIG. 8D). A UV laser is then used, without a prism, to cure the polymer material up to the extinction length of the UV light, forming the vertically aligned CNT membrane (FIG. 8E). A translating stage can be used to move the electrode apparatus in order to focus the UV light on different segments of the polymer. The resulting VACNT is then removed from the electrodes for etching and mounting (FIG. 8F).

FIGS. 9A-9B illustrate SEM images of 4-5 μm thick commercially available MWNT membranes created using solvent-deposition methods of the invention and a modified laser angle.

FIG. 10 illustrates a graph reporting pore size as a function of He—N₂ flowrate ratios, comparing the prior art with the bundle SWMT membranes of the invention.

FIG. 11 illustrates an SEM image of a membrane surface with approximately 1 μm thick SWNT bundles protruding from etched polymer.

FIGS. 12A-12D illustrate images of polymer infiltration after solvent-phase deposition of MWNTs. FIG. 12A illustrates MWNTs deposited in flow the cell after application of E-field. FIG. 12B illustrates the cell after polymer is injected into the setup with the flow directed from left to right. The image shows that CNTs are removed from the electrode surface both to the left and to the right of the polymer-CHP interface (blue dashed line) when compared to FIG. 12A, indicating that CNTs are wiped from the electrode as CHP flows past, and again as the polymer flows past the deposited CNTs. FIG. 12C illustrates an image showing the cured membrane in the electrode setup with a large portion CNTs removed, compared to the original deposition in FIG. 12A. FIG. 12D illustrates an image showing the results of improved infiltration using clean CHP, showing retention of most of the CNTs, as compared to FIG. 12C.

FIG. 13A illustrates an SEM image of a membrane fabricated using E-field deposition in polymer solution only, according to methods in the prior art.

FIG. 13B illustrates an SEM image of a membrane fabricated using the solvent-phase deposition methods of the invention demonstrating a 9-times higher nanotube density.

FIG. 13C illustrates an image comparing a membrane fabricated using E-field deposition in polymer solution only, according to methods in the prior art (left) and a membrane fabricated using the solvent-phase deposition methods of the invention (right).

FIGS. 14A-14B illustrate graphs showing the deposited number density of SWNT bundles as a function of time. FIG. 14A was recorded at 87.5 Vᵣₘₛ/mm with a stepped DC offset. CNTs detached from the electrode surface as the voltage was stepped up. FIG. 14B was recorded at two different constant-strength AC fields. CNTs were deposited while the DC offset ramped linearly from 0 to −2.5 V_{DC} over 5 minutes. The results of the optimized electric field (using the function defined in Equation 1) are also depicted.

FIG. 15 illustrates a graphical representation of the optimized electric field. The frequency of the graphed signal has been decreased from the experimental value of 10 Hz for better visibility. The black dashed line represents the DC offset of the signal.

FIGS. 16A-16B illustrate SEM images of membranes with SWNT bundles fabricated using the solvent-deposition methods of the invention. FIG. 16A illustrates a membrane bottom surface revealing a number of dimples located at protruding SWNT bundles. FIG. 16B illustrates a close-up of the membrane surface.

FIGS. 17A-17B illustrate schematics of a membrane of the invention: with a crater formed in the shadow of a nanotube protruding from the surface of the membrane (FIG. 17A); and after the crater has been filled in through spin coating (FIG. 17B).

FIG. 18 illustrates a graph showing spin-coating thicknesses as a function of the rotation speed and solution components.

FIGS. 19A-19B illustrate SEM images of SWNT bundle membranes before (FIG. 19A) and after (FIG. 19B) spin coating.

FIG. 20 illustrates a transport graph of SWNT bundle membranes strengthened with spin coating treated with O₂ plasma etching. One membrane (red diamond) is seen to open up and have a He—N₂ flowrate ratio after three rounds of 3 minutes of O₂-plasma etching at 100 W.

FIG. 21A illustrates a graph of He—N₂ flowrate graph for SWNT-bundle membranes fabricated with polymer-phase deposition (without any spin coating) and etched with O₂-plasma.

FIG. 21B illustrates a graph of detailed flow testing of SWNT-bundle membranes fabricated with polymer-phase deposition (without any spin coating) and etched with O₂-plasma, showing the flowrates at different values of the applied pressure.

FIG. 22A illustrates alignment, deposition, and curing for continuous production of VACNT membranes.

FIG. 22B illustrates a non-limiting exemplification of roll-to-roll fabrication according to methods of the present invention. This benchtop unit may be configured to perform process modules, such as Unwind & rewind systems; Tension control; Fluid coating; Drying (if needed); Electrophoretic alignment modules; UV curing modules; Lamination capability (for support webs as needed).

FIGS. 23A-23F illustrate aspects of preparation of a tri-layer membrane (polyurethane/silicone/polyurethane) according to methods of the present invention. FIG. 23A illustrates a plasma set-up used within the invention. FIG. 23B illustrates experimental etching rates for the polymers using various etching conditions. FIG. 23C illustrates images derived from various etching conditions. FIGS. 23D-23E illustrate a correlation of thickness vs. cure time for each layer of the trilayer membrane exemplified herein. FIG. 23F illustrates an EDX analysis of the trilayer membrane exemplified herein.

### DETAILED DESCRIPTION OF THE INVENTION

In one aspect, the invention provides novel methods of fabricating a polymer membrane comprising embedded, aligned carbon nanotubes.

In certain embodiments, the method comprises suspending nanotube bundles in a polymer precursor thereby forming a polymer precursor suspension. In other embodiments, the method comprises contacting the polymer precursor suspension with an electrode surface. In yet other embodiments, the method comprises electrodepositing the nanotube bundles onto at least a section of the electrode surface, such that the nanotube bundles are aligned (approximately) perpendicular to the electrode surface. In yet other embodiments, the method comprises curing the polymer precursor suspension thereby forming a polymer membrane comprising embedded nanotube bundles. In yet other embodiments, the method comprises removing the polymer membrane from the electrode. In yet other embodiments, the method comprises etching the polymer membrane surface(s) to expose the ends of the embedded nanotube bundles. In yet other embodiments, the steps of the method are repeated at least one time, so as to generate a multilayer membrane, wherein the polymer precursor suspension used in each repetition is independently selected.

In certain embodiments, the method comprises suspending nanotubes in a first solution to form a solution suspension. In other embodiments, the method comprises contacting the solution suspension with an electrode surface. In yet other embodiments, the method comprises electrodepositing the nanotube bundles onto the electrode surface, such that the nanotube bundles are aligned (approximately) perpendicular to the electrode surface. In yet other embodiments, the method comprises optionally flowing a second solution, which does not comprise suspended nanotubes, over the electrode surface in order to remove any nanotubes that have not been deposited onto the electrode surface. In yet other embodiments, the method comprises flowing a polymer precursor over the electrode surface, displacing any of the solutions present therein. In yet other embodiments, the method comprises curing the polymer precursor thereby forming a polymer membrane comprising embedded nanotubes. In yet other embodiments, the method comprises removing the polymer membrane from the electrode. In yet other embodiments, the method comprises etching the polymer membrane surface(s) to expose the embedded carbon nanotubes. In yet other embodiments, the steps of the method are repeated at least one time, so as to generate a multilayer membrane, wherein the polymer precursor suspension used in each repetition is independently selected.

In certain embodiments, the method comprises suspending nanotube bundles in a polymer precursor suspension. In other embodiments, the method comprises contacting the polymer precursor suspension to an electrode surface. In yet other embodiments, the method comprises electrodepositing the nanotube bundles on the electrode surface, such that the nanotube bundles are aligned (approximately) perpendicular to the electrode surface. In yet other embodiments, the method comprises photocuring the polymer precursor suspension using a light source, such that the polymer precursor suspension is selectively cured up to the extinction length of the light source wavelength, thereby forming a polymer membrane comprising embedded nanotubes. In yet other embodiments, the method comprises removing the polymer membrane from the electrode. In yet other embodiments, the method comprises etching the polymer membrane surface(s) to expose the ends of the embedded nanotubes. In yet other embodiments, the electrode is transparent to at least one wavelength of light from the light source. In yet other embodiments, the steps of the method are repeated at least one time, so as to generate a multilayer membrane, wherein the polymer precursor suspension used in each repetition is independently selected.

In another aspect, the invention provides polymer membranes formed through the methods of the invention. In certain embodiments, the polymer membranes comprise carbon nanotube bundles. In other embodiments, the polymer membranes comprise carbon nanotubes have a number density of about 9×10⁷ nanotubes/cm². In yet other embodiments, the methods of the invention yield polymer membranes having a 3-9 fold increase in nanotube number density over methods in the prior art. In yet other embodiments, the membrane is monolayered. In yet other embodiments, the membrane is multilayered.

### Definitions

As used herein, each of the following terms has the meaning associated with it in this section.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, exemplary methods and materials are described.

Generally, the nomenclature used herein and the laboratory procedures in polymer chemistry and materials science are those well-known and commonly employed in the art.

As used herein, the articles “a” and “an” refer to one or to more than one (i.e., to at least one) of the grammatical object of the article. By way of example, “an element” means one element or more than one element.

As used herein, the term “about” is understood by persons of ordinary skill in the art and varies to some extent on the context in which it is used. As used herein when referring to a measurable value such as an amount, a temporal duration, and the like, the term “about” is meant to encompass variations of ±20% or ±10%, more preferably ±5%, even more preferably ±1%, and still more preferably ±0.1% from the specified value, as such variations are appropriate to perform the disclosed methods.

The term “monomer” refers to any discrete chemical compound of any molecular weight.

As used herein, the term “polymer” refers to a molecule composed of repeating structural units typically connected by covalent chemical bonds. The term “polymer” is also meant to include the terms copolymer and oligomers. In certain embodiments, a polymer comprises a backbone (i.e., the chemical connectivity that defines the central chain of the polymer, including chemical linkages among the various polymerized monomeric units) and a side chain (i.e., the chemical connectivity that extends away from the backbone).

As used herein, the term “polymerization” refers to at least one reaction that consumes at least one functional group in a monomeric molecule (or monomer), oligomeric molecule (or oligomer) or polymeric molecule (or polymer), to create at least one chemical linkage between at least two distinct molecules (e.g., intermolecular bond), at least one chemical linkage within the same molecule (e.g., intramolecular bond), or any combinations thereof. A polymerization or crosslinking reaction may consume between about 0% and about 100% of the at least one functional group available in the system. In certain embodiments, polymerization or crosslinking of at least one functional group results in about 100% consumption of the at least one functional group. In other embodiments, polymerization or crosslinking of at least one functional group results in less than about 100% consumption of the at least one functional group.

Throughout this disclosure, various aspects of the invention may be presented in a range format. It should be understood that the description in range format is merely for convenience and brevity and should not be construed as an inflexible limitation on the scope of the invention. Accordingly, the description of a range should be considered to have specifically disclosed all the possible sub-ranges as well as individual numerical values within that range and, when appropriate, partial integers of the numerical values within ranges. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 2.7, 3, 4, 5, 5.3, and 6. This applies regardless of the breadth of the range.

The following abbreviations are used herein: AC, alternating current; CHP, 1-cyclohexyl-2-pyrrolidinone; CNT, carbon nanotube; CVD, chemical vapor deposition; DB, Direct Blue dye; DC, direct current; EDA, ethylene diamine; FWNT, few wall nanotube; MWNT, multi wall nanotube; PEG, poly(ethylene glycol); SA, commercially available carbon nanotubes (which can be procured from Sigma Aldrich, in a non-limiting example); SEM, scanning electron microscopy; SWNT, single wall nanotube; VACT, vertically aligned carbon nanotube MWNT, multi wall nanotube; PEG, poly(ethylene glycol); SA, commercially available carbon nanotubes (which can be procured from Sigma Aldrich, in a non-limiting example); SEM, scanning electron microscopy; SWNT, single wall nanotube; VACT, vertically aligned carbon nanotube.

### Methods

In one aspect, the invention provides novel methods of fabricating a polymer membrane comprising embedded, aligned carbon nanotubes. In certain embodiments, the methods of the invention are inexpensive compared to currently existing methods. In other embodiments, the methods of the invention are more easily and/or more economically scalable as compared to currently existing methods.

In certain embodiments, the methods of the invention allow for preparing a polymer membrane comprising nanotube bundles. In other embodiments, the method comprises suspending nanotube bundles in a polymer precursor, thereby forming a polymer precursor suspension. In other embodiments, the method comprises contacting the polymer precursor suspension with a substrate surface. In yet other embodiments, the method comprises electrodepositing the nanotube bundles on the substrate surface, such that the nanotube bundles are aligned (approximately) perpendicular to the substrate surface. In yet other embodiments, the method comprises curing the polymer precursor suspension, thereby forming a polymer membrane comprising embedded nanotube bundles. In yet other embodiments, the method comprises removing the polymer membrane from the substrate and etching the polymer membrane surface(s) to expose the ends of the embedded nanotube bundles.

In certain embodiments, the methods of the invention comprise solution deposition methods. In other embodiments, the method comprises suspending nanotubes in a first solution to form a solution suspension. In yet other embodiments, the method comprises contacting the solution suspension with a substrate surface. In yet other embodiments, the method comprises electrodepositing the nanotube bundles on the substrate surface, such that the nanotube bundles are aligned (approximately) perpendicular to the substrate surface. In yet other embodiments, the method comprises optionally flowing a second solution not comprising suspended nanotubes over the substrate surface, in order to remove any nanotubes that have not been deposited to the substrate surface. In yet other embodiments, the method comprises flowing a polymer precursor over the substrate surface, displacing any of the solutions in contact with the aligned nanotube bundles. In yet other embodiments, the method comprises curing the polymer precursor, thereby forming a polymer membrane comprising embedded nanotubes. In yet other embodiments, the method comprises removing the polymer membrane from the substrate. In yet other embodiments, the method comprises etching the polymer membrane surface(s) to expose the embedded carbon nanotubes.

In certain embodiments, the first solution comprises an organic solvent. In other embodiments, the second solution comprises an organic solvent. In yet other embodiments, the first and second solutions comprise solvents that do not dissolve or decay carbon nanotubes. In yet other embodiments, the first and second solution each comprises at least one solvent independently selected from the group consisting of 1-cyclohexyl-2-pyrrolidinone (CHP), acetone, dichloromethane, ethanol, isopropanol, hexanes, dichloroethane, dichlorobenzene and dimethylformamide. In certain embodiments, the first and second solution are the same. In other embodiments, the first and second solutions are different.

In certain embodiments, the methods of the invention comprise selective photocuring methods. In other embodiments, the method comprises suspending nanotube bundles in a polymer precursor suspension. In other embodiments, the method comprises contacting the polymer precursor suspension with a substrate surface, wherein the substrate is transparent to at least one wavelength of light from a light source. In yet other embodiments, the method comprises electrodepositing the nanotube bundles on the substrate surface, such that the nanotube bundles are aligned (approximately) perpendicular to the substrate surface. In yet other embodiments, the method comprises photocuring the polymer precursor suspension by exposing the polymer precursor to the light source through the transparent substrate such that the polymer precursor suspension is selectively cured up to the extinction length of the light source wavelength within the polymer precursor medium, thereby forming a polymer membrane comprising embedded nanotubes. In yet other embodiments, the method comprises removing the polymer membrane from the substrate. In yet other embodiments, the method comprises etching the polymer membrane surfaces to expose the ends of the embedded nanotubes.

In certain embodiments, the nanotubes are agglomerated in nanotube bundles. In other embodiments, the nanotubes are carbon nanotubes. In yet other embodiments, the carbon nanotubes are single walled nanotubes, double wall nanotubes, or any mixtures thereof. In yet other embodiments, the nanotubes are uncapped nanotubes, having an unblocked lumen throughout the length of each nanotube. In yet other embodiments, the nanotubes are functionalized with at least one functional group selected from the group consisting of amine groups, alkyl amine groups (such as but not limited to ethylene diamine (EDA)), carboxyl groups, phenolic groups, lactone groups, and hydroxyl groups. In yet other embodiments, the nanotubes are functionalized through exposure to ozone.

In certain embodiments, the nanotubes have a length of about 1 μm to about 200 μm. In other embodiments, the nanotubes have a length of about 5 μm to about 15 μm. In other embodiments, the nanotubes have a diameter of about 0.5 nm to about 150 nm. In other embodiments, the nanotubes have a diameter of about 1 nm to about 10 nm.

In certain embodiments, the polymer precursor is any polymeric material precursor known in the art. In certain embodiments, the polymer precursor comprises at least one monomer selected from, but not limited to, the group consisting of aromatic urethanes, aliphatic urethanes, urethane acrylates, silicones (or polysiloxanes, which in certain embodiments have the formula [R₂SiO]ₙ, where R is an organic group such as optionally substituted alkyl or optionally substituted phenyl), and multifunctional aromatic compounds. In other embodiments, the polymer precursor comprises at least one polymerization initiator. In yet other embodiments, the polymer precursor comprises at least one photoinitiator, such as but not limited to benzophenone and acetophenone. Non-limiting examples of commercially available photoinitiator include Darocur 1173, ME1403, ME1404, and/or ME1405.

In certain embodiments, the substrate is an electrode. In other embodiments, the substrate is a material layer disposed on the surface of an electrode such that the nanotubes are deposited on the substrate surface distal to the electrode surface. In certain embodiments, the substrate is stationary, forming a layer on top of the electrode surface. In other embodiments, the substrate is a mobile substrate, which can be freely moved over the electrode surface. In certain embodiments, the substrate material is a polymer substrate. In other non-limiting embodiments, the substrate material comprises at least one polymer material selected from the group consisting of polyethylene, cyclic olefin polymer, silicone, and polymethyl methacrylate. In yet other embodiments, the substrate material can be any material that is transparent to at least one wavelength of light in the group consisting of ultraviolet light (10-400 nm), visible light (400-750 nm), and/or infrared light (750 nm-1 mm) ranges.

In certain embodiments, the electrode comprises at least one metal. In other embodiments, the electrode comprises at least one transparent conductive oxide, such as, but not limited to, indium tin oxide coated onto quartz or glass. In other embodiments, the electrode comprises at least one transparent conducting polymer. In yet other embodiments, the electrode comprises a material transparent to at least one wavelength of light in the ultraviolet light (10-400 nm), visible light (400-750 nm), and/or infrared (750 nm-1 mm) ranges. In certain embodiments that utilize a mobile substrate, the electrode comprises a non-transparent portion and a transparent portion, such that the electrodeposition occurs at one or both portions of the electrode and photocuring of the polymer precursor occurs only through the transparent portion of the electrode.

In certain embodiments, the electrode is a cathode. In other embodiments, the electrode is an anode. The appropriate charge of the electrodepositing electrode can be determined based on the functionalization of the nanotubes and the identity of the solvents and polymer precursors.

In certain embodiments, the alignment and electrodeposition occurs through the application of an AC electric field to the electrode. In other embodiments, the electrodeposition occurs through the application of a DC electric field offset to the electrode. In yet other embodiments, the alignment and electrodeposition utilizes an AC electric field voltage of about 80 Vᵣₘₛ/mm to about 200 Vᵣₘₛ/mm. In yet other embodiments, the electrodeposition utilizes an AC electric field voltage of about 87.5 Vᵣₘₛ/mm to about 175 Vᵣₘₛ/mm. In yet other embodiments, the electrodeposition utilizes a DC electric field offset of about 0 V to about 5,000 V. In yet other embodiments, the electrodeposition utilizes a DC electric field offset of about 0 V to about −100 V. In yet other embodiments, the electrodeposition utilizes a DC electric field offset of about 0 V to about −2.5 V. In yet other embodiments, the electrodeposition utilizes a DC electric field offset of about −1 V to about −2 V. In yet other embodiments, the electrodeposition utilizes an electric field that is gradually decreasing over time in AC amplitude and increasing in DC offset, for example as defined in Equation (1):

$${E}_{AC} ( t ) \text{/} \frac{V}{mm} = \{ \begin{matrix}( 175 - 87.5 \frac{t}{150} ) \sqrt{2} sin 20 π t , t < 150 s \\ 87.5 \sqrt{2} sin 20 πt , t \geq 150 s\end{matrix} \\ {E}_{DC} ( t ) \text{/} V = - 2.5 \frac{t}{300} , \qquad ( 1 )$$

wherein, (t) is time. In yet other embodiments, the electrodeposition utilizes a DC electric field offset which increases as a function of time.

In certain embodiments, the polymer precursor is cured through photocuring. In other embodiments, the polymer precursor is photocured through the use of at least one photoinitiator, such as but not limited to benzophenone or acetophenone. In yet other embodiments, the polymer precursor is photocured through exposure to at least one wavelength of light in the ultraviolet light (10-400 nm), visible light (400-750 nm), and/or near-infrared light (750 nm-2,000 nm) ranges. In yet other embodiments, the polymer precursor is photocured through exposure to ultraviolet light. In yet other embodiments, the polymer precursor is photocured through exposure to light with a wavelength from about 230 nm to about 300 nm. In yet other embodiments, the polymer precursor is photocured through exposure to light with a wavelength from about 250 nm to about 290 nm. In yet other embodiments, the polymer precursor is photocured through exposure to light with a wavelength of about 254 nm. In yet other embodiments, the polymer precursor is photocured through exposure to laser light. In yet other embodiments, the polymer precursor is photocured through exposure to light provided by at least one LED. In yet other embodiments, the polymer precursor is photocured through exposure to collimated light. In yet other embodiments, wherein the electrode comprises a material transparent to the photocuring light, the polymer precursor suspension is selectively cured through exposure to a light source through the electrode, wherein the polymer precursor is cured only up to the extinction length of the light source wavelength within the polymer precursor medium. In certain embodiments comprising selective photocuring, one or more parameters, including but not limited to light source intensity and angle of incidence of the light, are modified in order to control the depth of cure. In certain embodiments, the angle of incidence of the light ranges from 90° (normal to the surface of the electrode) to about 40°, wherein 0° degrees is defined as parallel to the surface of the electrode. In yet other embodiments, the polymer precursor is heat cured. In yet other embodiments, the polymer precursor is chemically cured.

In certain embodiments, the polymer membrane is etched through the use of O₂-plasma. In other embodiments, the polymer membrane is etched through the use of O₂-plasma at a power of about 50 W to about 250 W, or about 100 W to about 225 W. In yet other embodiments, the polymer membrane is etched through reactive-ion etching using any reactive ion gases known in the art for use in reactive-ion etching, such as but not limited to O₂-plasma, N₂-plasma, SF₆-plasma, air plasma, CF₄ plasma, and any mixtures or combinations thereof. In yet other embodiments, the etching occurs at reduced pressure (less than atmospheric pressure). In yet other embodiments, the etching occurs at atmospheric pressure. In other embodiments, the polymer membrane is etched through electrochemical etching. In yet other embodiments, the polymer membrane is electrochemically etched through the use of a layer of sputtered gold. In yet other embodiments is electrochemically etched with an applied voltage of about 2.5 V to about 3.5 V. In certain embodiments, the polymer membrane is etched for an amount of time required to expose the ends of the embedded carbon nanotubes, such that the lumen of the nanotubes extends through the polymer membrane.

In certain embodiments, an etching process can be used to open nanotube pores that have been blocked during the fabrication process.

In certain embodiments, the method is conducted using a microfluidics device. In certain embodiments, the resulting polymer membrane has a thickness of about 1-10 μm, such as for example 1 μm, 1.5 μm, 2 μm, 2.5 μm, 3 μm, 4 μm, 4.5 μm, 5 μm, 5.5 μm, 6 μm, 6.5 μm, 7 μm, 7.5 μm, 8 μm, 8.5 μm, 9 μm, 9.5 μm, and/or 10 μm.

In certain embodiments, the methods of the invention can be used to produce multilayer membrane, which comprise two, three, four, five, six, seven, eight, nine, ten, or more than ten membranes, which are each independently selected. Each of these layers can be the same or different from the neighboring layers. The thickness and/or composition of each layer can be independently selected. In certain non-limiting embodiments, each layer can be optimized for different properties. In other non-limiting embodiments, at least one layers from the multilayer membrane is selected for its enhanced mechanical strength. In yet other non-limiting embodiments, at least one layer from the multilayer membrane is selected for its etch resistance.

In certain embodiments, parameters such as, but not limited to, flow rates, voltages and potentials, cure time and light intensity can be modified. For example, flow rate and electric field strength can be adapted and can be different in embodiments utilizing solution phase nanotube deposition versus embodiments utilizing nanotubes suspended in polymer precursors.

### Polymer Membranes

In another aspect, the invention provides a porous polymer membrane comprising embedded aligned carbon nanotubes, wherein the aligned carbon nanotubes, each having an unobstructed lumen, extend through the polymer membrane such that the lumen of the aligned carbon nanotubes define a pore extending from one surface of the membrane to the opposing surface of the membrane.

In certain embodiments, the porous polymer membrane comprises a high density of carbon nanotubes. In other embodiments, the porous polymer membrane comprises more than about 1×10⁷ nanotubes/cm². In yet other embodiments, the porous polymer membrane comprises about 1×10⁷ nanotubes/cm² to about 1×10⁸ nanotubes/cm². In yet other embodiments, the porous polymer membrane comprises more than about 1×10⁸ nanotubes/cm². In certain embodiments, solution-fabricated membranes have number densities of aligned nanotubes up to about 1×10¹⁰ nanotubes/cm² for single-wall carbon nanotubes, and about 1×10⁸ for multi-wall carbon nanotubes.

In certain embodiments, the nanotubes are carbon nanotubes. In other embodiments, the carbon nanotubes are single walled nanotubes, double wall nanotubes or a mixture of both. In yet other embodiments, the nanotubes are uncapped nanotubes, having an unblocked lumen throughout the length of each nanotube. In yet other embodiments, the nanotubes are functionalized with at least one functional group selected from the group consisting of amine groups, alkyl amine groups (such as but not limited to ethylene diamine (EDA)), carboxyl groups, phenolic groups, lactone groups, and hydroxyl groups. In yet other embodiments, the nanotubes are functionalized through exposure to ozone.

In certain embodiments, the nanotubes have a length of about 1 μm to about 200 μm. In other embodiments, the nanotubes have a length of about 5 μm to about 15 μm. In certain embodiments, the nanotubes have a length of about 1 μm, 1.5 μm, 2 μm, 2.5 μm, 3 μm, 4 μm, 4.5 μm, 5 μm, 5.5 μm, 6 μm, 6.5 μm, 7 μm, 7.5 μm, 8 μm, 8.5 μm, 9 μm, 9.5 μm, and/or 10 μm.

In certain embodiments, the nanotubes have a diameter of about 0.5 nm to about 150 nm. In other embodiments, the nanotubes have a diameter of about 1 nm to about 10 nm.

In certain embodiments, the nanotubes are agglomerated together in nanotube bundles. In other embodiments the nanotube bundles are carbon nanotube bundles. In yet other embodiments, the nanotube bundles comprise single walled nanotubes, double wall nanotubes or a mixture of both. In yet other embodiments, the nanotube bundles comprise uncapped nanotubes, having an unblocked lumen throughout the length of each nanotube. In yet other embodiments, the nanotube bundles comprise nanotubes functionalized with at least one functional group that promotes bundling. In yet other embodiments, the nanotube bundles comprise nanotubes functionalized with at least one functional group selected from the group consisting of amine groups, alkyl amine groups (such as but not limited to ethylene diamine (EDA)), carboxyl groups, phenolic groups, lactone groups, and hydroxyl groups. In yet other embodiments, the nanotubes are functionalized through exposure to ozone.

In certain embodiments, the resulting polymer membrane has a thickness of about 1-10 μm, such as for example about 1 μm, 1.5 μm, 2 μm, 2.5 μm, 3 μm, 4 μm, 4.5 μm, 5 μm, 5.5 μm, 6 μm, 6.5 μm, 7 μm, 7.5 μm, 8 μm, 8.5 μm, 9 μm, 9.5 μm, and/or 10 μm.

In certain embodiments, the porous polymer membrane comprises at least one polymeric material selected from the group consisting of aliphatic polyurethane polymers, aromatic polyurethane polymers, polyurethane acrylate polymers, silicone, and polyaromatic polymers.

In certain embodiments, the porous polymer membrane is fabricated through a method of the invention, as described elsewhere herein.

Those skilled in the art will recognize, or be able to ascertain using no more than routine experimentation, numerous equivalents to the specific procedures, embodiments, claims, and examples described herein. Such equivalents were considered to be within the scope of this invention and covered by the claims appended hereto. For example, it should be understood, that modifications in reaction conditions, including but not limited to reaction times, reaction size/volume, and experimental reagents, such as solvents, catalysts, pressures, atmospheric conditions, e.g., nitrogen atmosphere, and reducing/oxidizing agents, with art-recognized alternatives and using no more than routine experimentation, are within the scope of the present application.

It is to be understood that, wherever values and ranges are provided herein, the description in range format is merely for convenience and brevity and should not be construed as an inflexible limitation on the scope of the invention. Accordingly, all values and ranges encompassed by these values and ranges are meant to be encompassed within the scope of the present invention. Moreover, all values that fall within these ranges, as well as the upper or lower limits of a range of values, are also contemplated by the present application. The description of a range should be considered to have specifically disclosed all the possible sub-ranges as well as individual numerical values within that range and, when appropriate, partial integers of the numerical values within ranges. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 2.7, 3, 4, 5, 5.3, and 6. This applies regardless of the breadth of the range.

The following examples further illustrate aspects of the present invention. However, they are in no way a limitation of the teachings or disclosure of the present invention as set forth herein.

### EXAMPLES

The invention is now described with reference to the following Examples. These Examples are provided for the purpose of illustration only, and the invention is not limited to these Examples, but rather encompasses all variations that are evident as a result of the teachings provided herein.

### Example 1: VACNT Membranes Comprising Bundled Nanotubes

Procedures were developed to successfully fabricate VACNT membranes using single-and-double-walled functionalized nanotubes. Two advantages of these CNTs is that are easier to uncap (being few-walled), and have high MVTR and N₂ permeances. Thus, they are not intrinsically blocked by bamboo structure or catalyst particles. For use in the solution-base fabrication scheme, these CNTs were first functionalized by Chasm Technologies with ethylene diamine (EDA) to promote bundling in suspension.

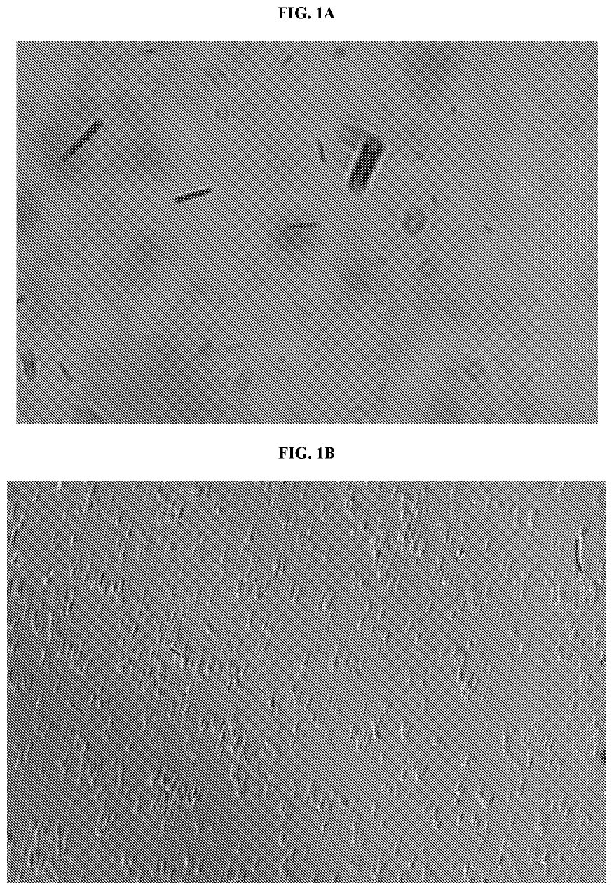

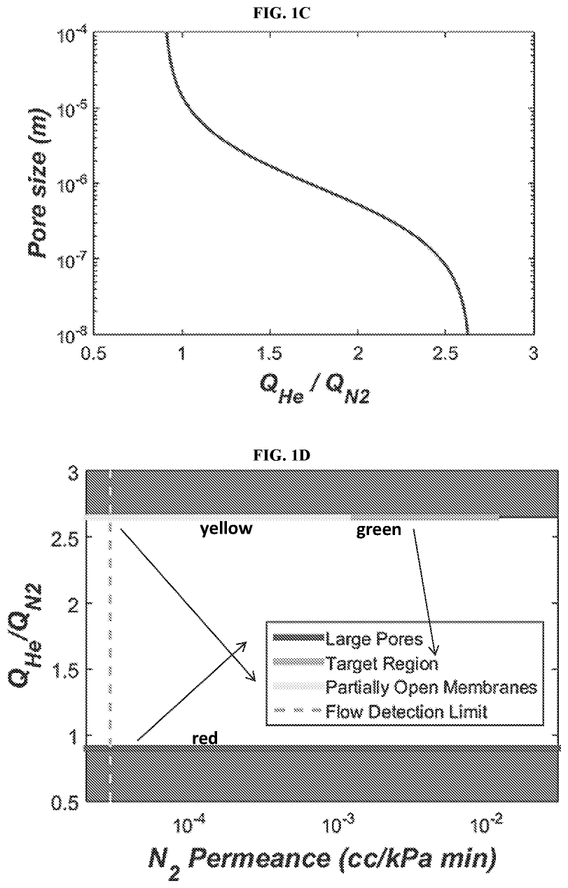

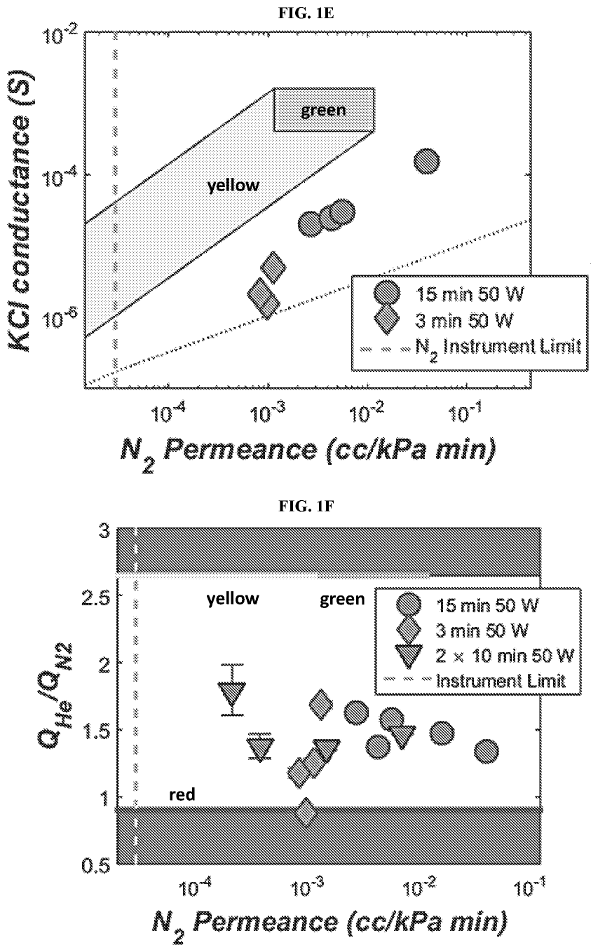

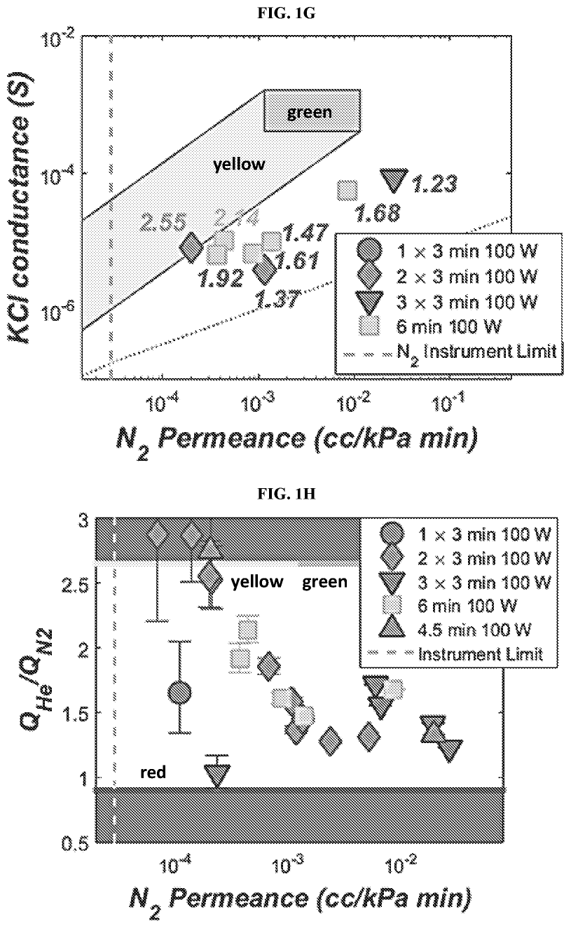

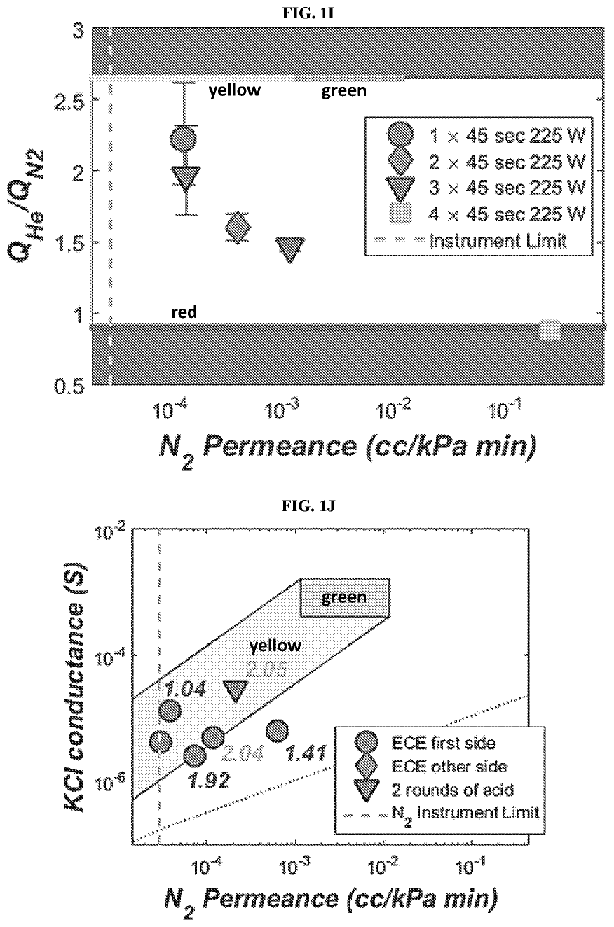

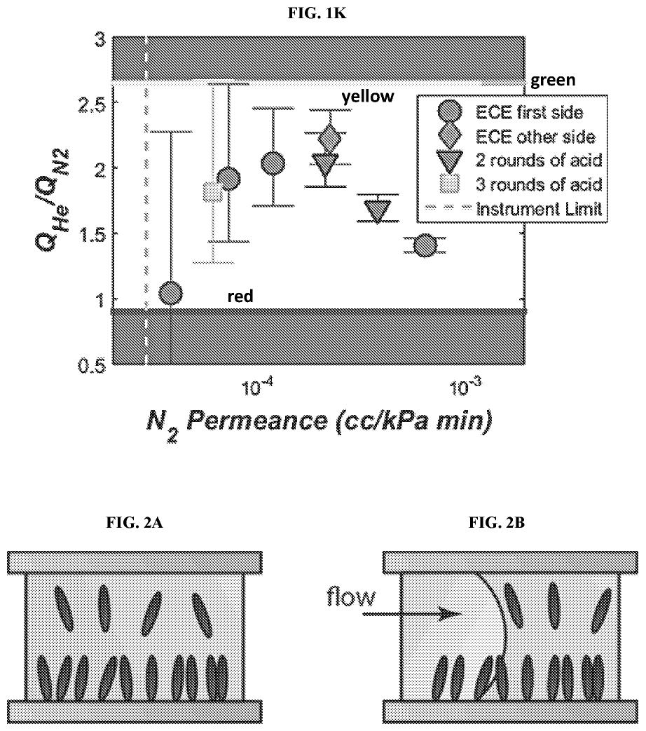

To suspend the nanotubes in polymer solution, the EDA-treated CNT wafer was submerged in DCE and bath sonicated 3-5 min to detach bundles of few-walled nanotubes. Once the bundles were freely suspended, the reactive diluent component of the polymer suspension was mixed in. Since DCE can weaken the membrane, the DCE was allowed to evaporate, leaving nanotube bundles in the reactive diluent, which was then combined with the other components of the polymer mixture. The final resulting suspension was bath sonicated again to break apart agglomerated bundles and achieve a dispersion seen in FIG. 1A. The suspension was then electrodeposited and laser cured to create membranes with 10⁶ bundles/cm², as seen in FIG. 1B. Depending on the number of nanotubes contained within the bundles, this can represent number densities on the order of 10⁸ CNTs/cm².

He—N₂ flowrate ratio is an efficient yet stringent way to test for nanometer-sized pores without defects in the VACNT membranes. Membranes with N₂ flowrates and KCl conductance measurements that would seem to indicate ˜1 μm defects can still, for example, reject 50 nm Au particles. However, the He—N₂ flowrate ratio is a strong function of pore size, as seen in FIG. 1C. Here, as the flowrate ratio has a one-to-one correspondence with pore size for diameters between ˜10 nm to ˜10 μm, it is possible to make a pore size estimation with the He—N₂ flowrate ratio over this diameter range. As the ratio approached 2.65, the calculated pore size dropped into the 1-10 nanometer range, which would be consistent with flow through nanotube pores. To characterize the transport for different membranes, measured He—N₂ flowrate ratios and N₂ permeance were plotted on flowrate graphs as shown in FIG. 1D. When data was plotted on this graph, one would expect flow through ˜1.6 nm-diameter FWNTs at the target number densities to lie along the green line. The yellow line represents predicted transport values for membranes with the same pore diameter, but a lower number density of pores. This would account for incomplete opening (i.e., opening of only some fraction) of the nanotube pores.

Numerous membranes were fabricated using FWNTs grown via CVD at LLNL and then functionalized with ethylene diamine (EDA) by Chasm Technologies; the functionalization enhances dispersability of the nanotubes and promotes controlled bundling, which makes it possible to achieve higher nanotube number density. Because these CNTs are much thinner than the previous SA CNTs, it was anticipated that O₂-plasma etching could open the CNTs without inducing defects in the polymer. To strengthen the membranes, they were further exposed to photoinitiator and UV light for 5 min, after fabrication and mounting. This is expected to increase the degree of crosslinking in the polymer and increase resistance to O₂-plasma etching. If defects are opened up in membranes, they are expected to dominate the flow, and make it extremely difficult to determine if CNT pores have (also) been opened. Therefore in the search for the best O₂-plasma treatment parameters, it is difficult to quantitatively compare any two treatments which both open up defects. The search for optimal etching was accomplished by trial of a wide variety of treatment parameters. In particular, etching was performed at 50 W, 100 W and 225 W for different durations.

When etched at 50 W, the membranes that opened up were clearly seen to lie far away from the target regions in both the N₂—KCl transport graph and the N₂—He flowrate graph, as shown in FIG. 1E. The N₂—He flowrate ratios were consistently lower than 1.8, implying pores larger than 800 nm exist in these membranes. This led to the conclusion that all of these membranes had defects and that etching at 50 W is not optimal for opening CNT pores.

FWNT membranes were next etched at 100 W with O₂-plasma. With these treatments, as seen in FIGS. 1G-1H, five membranes were observed to hit the yellow target region in FIG. 1H. Four of these membranes were treated with O₂-plasma at 100 W for 2×3 min before reaching the yellow target region, while the other was etched in a single round of 4.5 minutes at 100 W. One etched membrane within the target region was tested for size-exclusion with 15 nm Au particles and was found to reject 99.3% of the particles. This membrane had an N₂ flowrate at least 6 times smaller than all other membranes that passed permeate (with or without rejection) in the past. This suggests permeate was recovered for this membrane with extremely small gas flowrate, because for a given N₂ flowrate, compared to membranes with defects, membranes with CNT pores may be expected to pass liquid water much faster due to flow enhancement. Because these membranes hit the yellow region that corresponds to incomplete opening of CNT pores, the three other membranes were subsequently treated with a third round of O₂-plasma. With the third round of 100 W O₂-plasma etching, the membranes all increased drastically in their flowrates while the He—N₂ flowrate ratio decreased below 2, indicating that defects were finally opened in the membranes.

A slight variation of the successful etching parameters, trying a single O₂-plasma etch for 6 min instead of 2×3 min, was then investigated. It was hoped that the fewer repetitions of etching would increase the membrane quality, because, each time the plasma etching is stopped, incomplete desorption of reacted species can contaminate the membrane surface. With this single round of etching, all of the resulting membranes were observed to have He—N₂ flowrate ratios below 2.2, signifying pores larger than 350 nm. This suggests that etching with O₂-plasma for 6 min is actually stronger than 2×3 min. However, when two of these membranes treated with O₂-plasma for 6 min were tested for size exclusion of 15 nm particles, they were found to nonetheless reject 95.4-98.4% of the particles. It is possible that much of the permeate passed through CNT pores while a smaller portion of the permeate passed through defects. If the KCl conductance of these membranes seen in the transport graph of FIG. 1G is examined, it is observed that the membrane treated with O₂-plasma for 2×3 min (depicted as a red diamond) lies in close proximity to membranes treated with O₂-plasma for 6 min (depicted as yellow squares). The N₂—KCl transport measurements by themselves are not conclusive because of N₂ flow enhancement in CNTs that can affect the results. It also suggests that the He—N₂ flowrate ratio is a stringent test for nanoscale pores as opposed to defects. This is because the flowrate ratio is most strongly influenced by the pores with the highest flow, so if even if there are many small pores and only a few larger defects, the larger defects will show in the resulting flowrate ratio for the membrane.

When four more membranes were etched with 100 W O₂-plasma for 4.5 min (instead of 6 min), one membrane was found to hit the yellow target region and another membrane had defects (green triangles in FIG. 1H.); two other membranes did not open up.

Next, membranes made with FWNTs were etched with O₂-plasma at 225 W in intervals of 45 seconds. As before, pore sizes in these membranes were characterized by measuring He and N₂ flowrates. As FIG. 1I shows, these membranes appear to start with few, small defects which then open up and increase in pore size as the membranes are etched further. This behavior is consistent with defects that exist in the polymer because they could easily increase in pore size with additional etching.

Based on these systematic studies, it appears that O₂ plasma etching at 100 W for 2×3 min or in a single treatment for 4.5 min most consistently opens nanotube-sized pores in FWNT membranes without creating larger defects.

FWNT membranes have also been treated with ECE to open CNT pores, which has been shown to successfully uncap for SA CNTs. The membranes, once strengthened with additional photoinitiator (Darocur), were briefly etched with O₂-plasma for 3 min at 50 W to clean any excess polymer off of the CNTs and expose CNT tips. Then, a 50 nm layer of Au was sputtered onto one membrane surface serve as an electrode and make contact with one end of the VACNTs. The membrane with a sputtered electrode was then etched for 1 hour in KCl solution with an applied voltage of 2.5-3.3 V. After this treatment, the membrane was exposed to HCl and H₂O₂ vapors to dissolve the gold. Membranes treated in this way have transport properties (KCl conductance and N₂ permeance) shown as blue circles in FIGS. 1J-1K. Some membranes have increased in permeance into the measurement range. Next, this treatment was repeated for the other side of these membranes. As the black triangles depict in FIGS. 1J-1K, now only one membrane has gas flow in the measurement range. Without wishing to be limited by any theory, this can be due to incomplete dissolution of the gold layer, which could block pores. Thus, these membranes were treated with additional acid-vapor wash. After a second round of acid-vapor wash, another membrane sealed up, and after a third round of acid treatment, one membrane opened while another sealed. This inconsistent behavior is believed to be due to reconfigure of the polymer matrix causing small holes to seal or open in the presence of the acid vapor. This hypothesis is supported by the fact that none of the ECE-treated membranes have He—N₂ flowrate ratios in the range where we would expect for nanometer sized pores, as shown in FIG. 1K. The membranes showed some resistance to acid treatment.

### Example 2: Two-Step Solvent/Polymer Methods of Forming VACNT Membranes

Previous methods have achieved number densities of 10⁷ CNTs/cm² with SA and NTL CNTs alike using an optimized polymer solution and electrodeposition parameters. To significantly increase the VACNT number density, a two-step process was developed in which the CNTs are deposited in a solvent, 1-cyclohexyl-2-pyrrolidinone (CHP), and then the UV curable polymer solution is injected to displace the CHP and allow for UV curing of a VACNT membrane. This process is schematically illustrated in FIGS. 2A-2B. The CHP has a much higher affinity for CNTs than the polymer, and is therefore able to suspend CNTs at a much high concentration, resulting in a denser deposition. In this way, the solvent can be selected solely for increased electrodeposition number density, and the polymer can be chosen for membrane strength. By optimizing these two steps independently, stronger membranes with a higher number density of CNTs can be produced.

Table 1 summarizes solvents that were examined for their ability to disperse and deposit SA CNTs. Of all the solvents studied, CHP was the best when considering all of the key aspects: the ability to disperse the CNTs without agglomerates, the alignment of the CNTs in the solvent without chaining, and most importantly the quality and density of electrodeposition. The alignment and electrodeposition of Sigma-Aldrich MWNTs from CHP was studied at initial concentrations of 1, 2 and 5 g/l. Electrodeposition was observed at all concentrations, but it was difficult to optically visualize the alignment of the nanotubes at the higher concentrations. Thus, to verify that the deposited CNTs were aligned, an initial nanotube concentration of 1 g/l was used to make it easy to observe the process in the microfluidic apparatus depicted in FIGS. 2A-2B.

TABLE 1
Electrodeposition properties for various solvents. Comparison
is made to the current polymer system, which is a 3:1
mixture of SU 704-LR 8887 + 4% Darocur 1173.

| | Conc. | | Align- | Resist. to | Deposi- |
|---|---|---|---|---|---|
| Solutions | (g/l) | Dispersbility | ment | chaining | tion |
| Current polymer | 2 | Good | Good | Good | Good |
| Acetone | 1 | Poor | N/A | N/A | N/A |
| Isopropanol | 1 | Poor | N/A | N/A | N/A |
| dichlorobenzene | 1 | Good | Poor | N/A | N/A |
| dichloroethane | 1 | Moderate | Good | Poor | Poor |
| dimethylformamide | 1 | Good | Good | Moderate | Poor |
| 1-cyclohexyl- | 1 | Good | Good | Good | Good |
| 2-pyrrolidinone | 2 | Good | Good | Good | Good |
| | 5 | Good | Good | Good | Good |

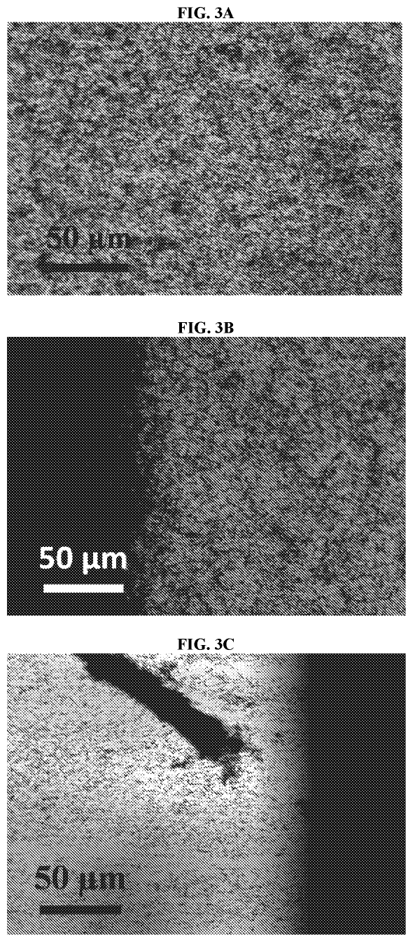

The initial results of electrodeposition in CHP can be seen in FIGS. 3A-3C, where the electrode surface is resolved under an optical microscope. A relatively high number density of aligned MWNTs is visible. However, as the polymer is injected into the electrode setup to displace the CHP, a discrete dark interface enters into the field of view (FIG. 3B). This dark band, whose leading edge forms at the interface between the CHP suspension and the polymer solution, is seen to collect CNTs from the CHP solution that were not deposited during electrodeposition. These CNTs flocculate in contact with the polymer solution, creating a CNT-agglomerate cloud which drags along the electrode surface and removes previously aligned and deposited CNTs. A much cleaner electrode surface can be seen in FIG. 3C after the polymer solution is injected to replace the CHP.

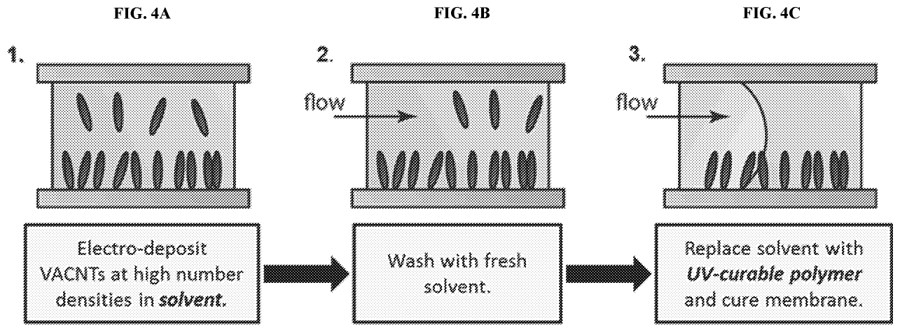

To retain deposited CNTs after polymer injection, the two-step process was modified to first remove any undeposited CNTs from the bulk solution with an injection of neat CHP. Because this injection does not have a discrete interface, CNTs in the bulk can diffuse from the loaded CHP phase to the neat CHP phase, which prevents large, dense agglomerated from forming as seen in FIG. 4A-4C. This infiltration technique was attempted using Sigma-Aldrich CNTs at an initial concentration of g/l in CHP, and it was possible to infiltrate UV curable polymer and cure a membrane while retaining the electric-field-aligned-and-deposited CNTs. As seen in FIG. 5, the cured membrane was measured to have number densities of approximately 2.3×10⁷ CNTs/cm². This is approximately a factor of two higher that number densities achieved with the polymer system, despite the low starting CNT concentration of 1 g/l in CHP.

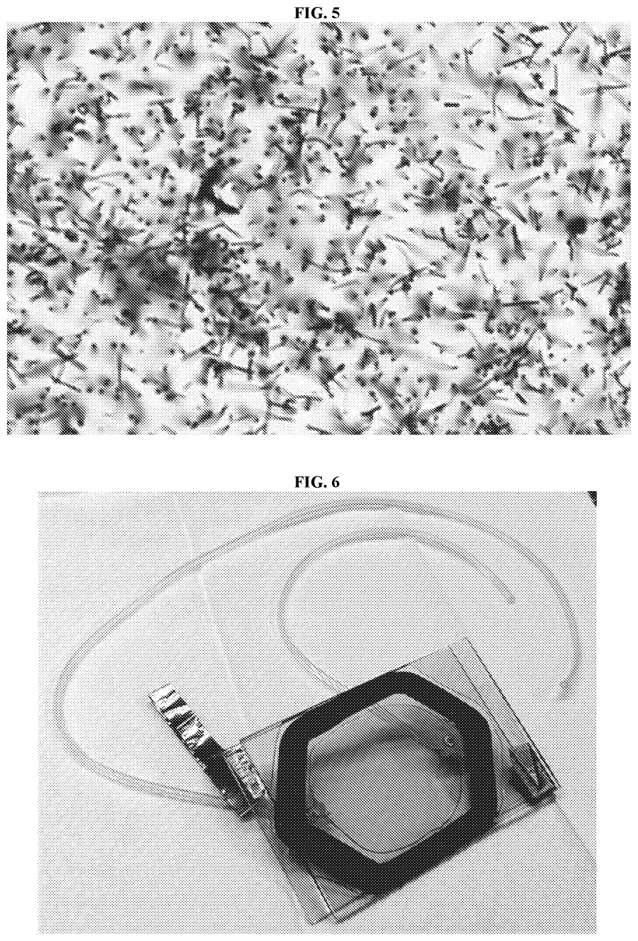

Development of the two-step solvent-deposition technique was continued to significantly increase CNT number density in solution-fabricated membranes, using Sigma-Aldrich (SA) MWNTs as the reference material for comparison with previous results. In this technique, CNTs are first suspended in CHP, which is an excellent solvent for CNTs. The nanotubes suspension is then introduced into a microfluidic apparatus (FIG. 6), and nanotubes are aligned and electro-deposited on the electrode surface. Then, polymer was infused into the setup and cured with the laser. Systematic deposition studies were conducted under the microscope to optimize parameters to achieve the maximum number density of vertically aligned CNTs. Compared to the more viscous polymer solution, the CHP-nanotube suspensions had much stronger electro-convective motions in the presence of the applied E-field. This motion, if too strong, was seen to knock over aligned CNTs. The electro-convection was much less significant in an AC field alone, so the motion appeared to be induced by the DC component of the field. Thus, to reduce the fluid motion, the process was started with a lower DC voltage to 2.5 V. The DC offset was then gradually increased over time to account for the screening that gradually occurs due to electrochemical reactions or double layer formation on the electrodes. This E-field with increasing DC component effectively deposits additional aligned CNTs on the electrode surface, while still minimizing the fluid motions in the bulk that can disturb the alignment of already deposited nanotubes.

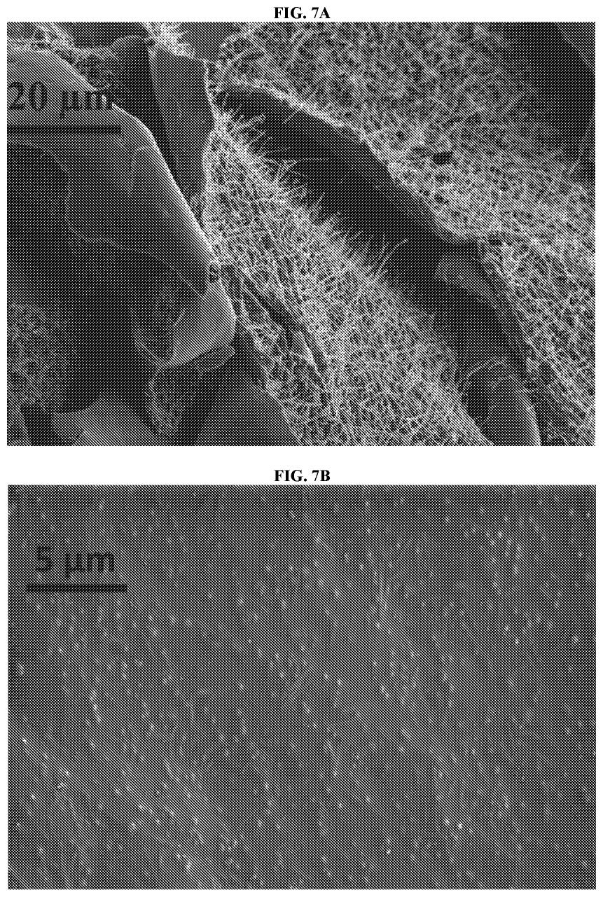

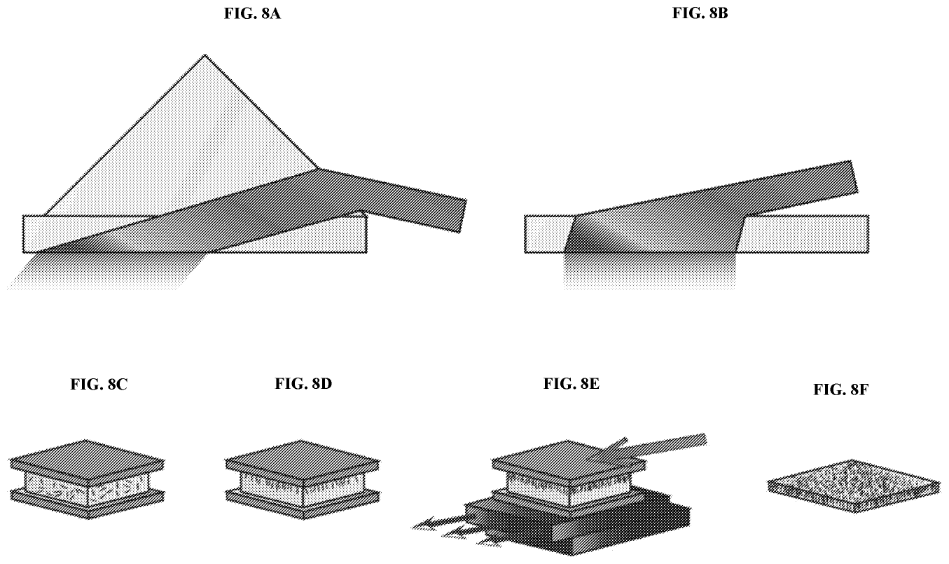

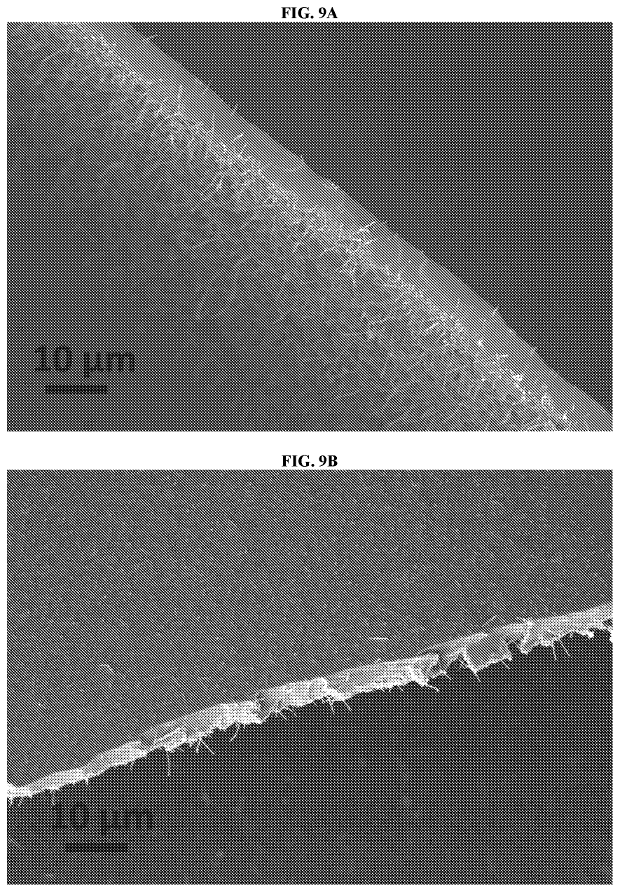

Using this solvent-deposition technique and a slowly increasing DC component to the E-field, laser-cured membranes were made with SA MWNTs and compared with previous results using alignment and deposition from a polymer suspension directly. FIGS. 7A-7B show SEM images of a cross-section and top surface of a membrane created with the new technique. The number density of vertically SA CNTs was measured to be 7×10⁷ CNTs/cm², which is 7 times higher than achieved in the past. Thus, solvent deposition is capable of dramatically increasing the number density of deposited CNTs, and is a promising path for the creation of highly permeable VACNT membranes. With the increased number density of the VACNTs, the membrane thickness that was initially cured by the laser was only ˜1 μm, which is too thin for the desired membrane strength. To increase the cure thickness through such a dense forest of CNTs (and already at the maximum laser power and minimum translation rates), the laser angle of incidence was modified, as seen in FIGS. 8A-8B. The laser setup with a prism was previously used as shown in FIG. 8A. The slight angle at which the laser hits the polymer can cure the polymer at thicknesses much less than the extinction length of the light in the polymer. By changing the angle of incidence of the UV light to a setup seen in FIG. 8B, the light enters into the polymer at a much steeper angle. In certain non-limiting embodiments, this helps increase the cure thickness: the UV light is not blocked as much by the CNTs from this angle, and the direction of the light results in membranes that cure to depths close to the UV extinction length in the polymer. FIGS. 8C-8F demonstrate a step by step process for this selective curing process. The carbon nanotube solution is first placed between transparent electrodes (FIG. 8C). The electric field is then used to align the nanotubes and the electrophoretic concentration increases (FIG. 8D). A UV laser is then used, without a prism, to cure the polymer material up to the extinction length of the UV light, forming the vertically aligned CNT membrane (FIG. 8E). A translating stage can be used to move the electrode apparatus in order to focus the UV light on different segments of the polymer. The resulting VACNT is then removed from the electrodes for etching and mounting (FIG. 8F). The laser incidence angle and other parameters were optimized, achieving the desired 4-5 ηm thick cure for membranes with a high density of 7×10⁷ CNTs/cm², as seen in FIGS. 9A-9B.

### Example 3: Advancements in VACNT Membranes Comprising Bundled Nanotubes

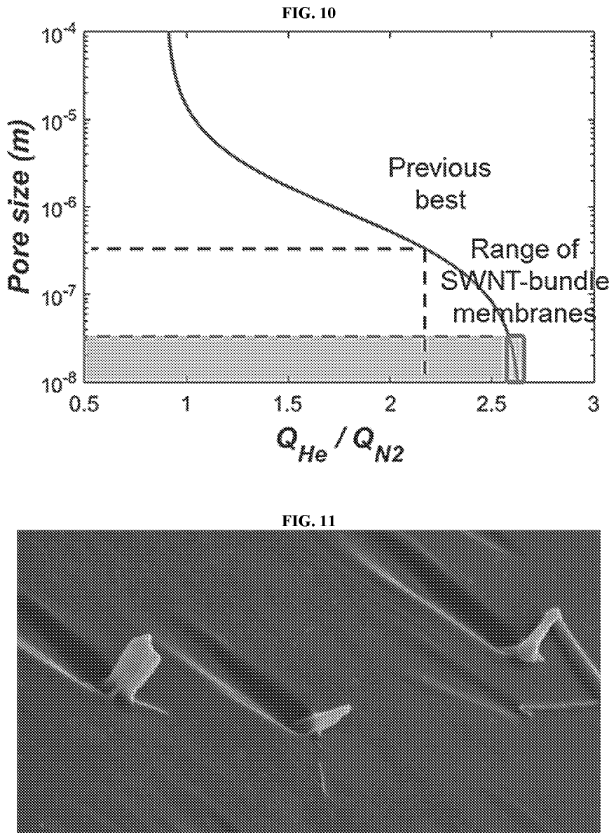

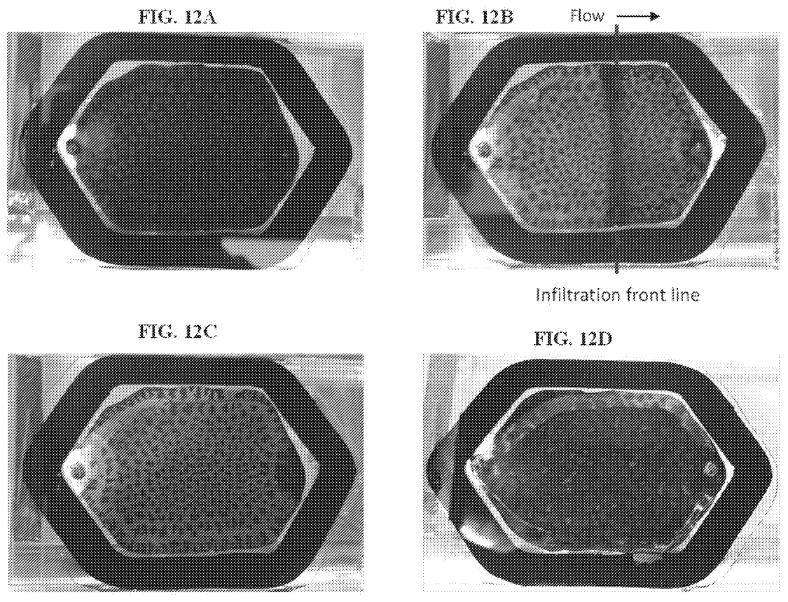

The fabricated VACNT Membranes reported in Example 1 showed high He—N₂ flowrate ratios consistent with those of CNT pores (FIG. 10). These membranes were created with electric-field alignment and deposition of LLNL-grown, Chasm-EDA-treated SWNT bundles in an aromatic polymer solution. The membranes had up to 5×10⁵ SWNT bundles/cm². SEM images of such a membrane are shown in FIG. 11.

Development of this fabrication procedure was continued by creating 119 of these SWNT-bundle membranes, etching them with O₂-plasma at 100 W, and testing them with gas-flow measurements. The gas-flow measurements, which can be a stringent test for defects, is highly sensitive to the presence of even a few large pores. In particular, by measuring the ratio of He and N₂ flow through the membrane, it is possible to calculate the pore size using the dusty gas flow model:

$$d = \frac{32}{3 {P}_{ave} {μ}_{{N}_{2}}} \sqrt{\frac{8 RT}{π {M}_{{N}_{2}}}} \cdot \frac{\sqrt{{M}_{{N}_{2}} \text{/} {M}_{He}} - \frac{{Q}_{He}}{{Q}_{{N}_{2}}}}{\frac{{Q}_{He}}{{Q}_{{N}_{2}}} - \frac{{μ}_{{N}_{2}}}{{μ}_{He}}} ,$$

where d is the pore size in the membrane, Pₐᵥₑ is the average pressure on both sides of the membrane, R is the gas constant, T is the temperature, M_{N2} and M_{He} are the molar masses, μ_{He} and μ_{N2} are the viscosities, and Q_{He} and Q_{N2} are the flowrates of the two gases. In the case where the membranes have polydisperse pore size, this pore-size measurement is heavily weighted towards the pores with the largest flowrates, i.e. the largest pores. For this reason, the gas-flow measurements are highly sensitive to defects in the membrane. The predictions of this equation for monodisperse pore size vs He—N₂ flowrate ratio can be seen graphed in FIG. 10.

As seen in Table 2, of the 33 membranes which were tested for both He and N₂ flow, 7 membranes had He—N₂ flowrate ratios between 2.4 and 2.65, which is within the range of nanoscale pores given the uncertainty of the measurement. The membranes were further tested with size-exclusion tests using aqueous solutions of PEG-functionalized 5 nm Au nanoparticles, PEG-functionalized 15 nm Au nanoparticles, or Direct Blue (DB) 71 dye (which has dimensions of approximately 3×1.5×1 nm³). Of the 43 membranes challenged with liquid-phase size-exclusion testing under an applied pressure of 5 psi, 6 membranes broke and 23 passed no measureable permeate within the maximum duration of approximately 2 days that was allowed for each test. As a control, 4 membranes were tested with only deionized water; only two of these membranes passed permeate, suggesting that some of the membranes which are permeable to gas flow are less permeable to liquids. Of the 3 membranes that passed solutions of DB71 dye, one showed successful rejection of 99.26% and two showed poor rejection. The only membrane which passed permeate with 5 nm Au nanoparticles showed no rejection. All 3 of the membranes which passed permeate with 15 nm Au nanoparticles showed successful rejections of between 95.40%-99.27%. The smallest known viruses are approximately 18 nm in diameter, so all three of these latter membranes would be bioprotective.

TABLE 2
Summary of characterization tests on membranes with SWNTs.

| | | Volume | | | N₂ | |
|---|---|---|---|---|---|---|
| | | Re- | Du- | | Permeance | |
| Mem- | Particle | covered | ration | | (cc/kPa | Q_{He}/ |
| brane | or Dye | (μl) | (days) | Rejection | mm) | Q_{N2} |
| GD4 | DI water | 0 | 1.8 | | 6.29E−04 | 1.69 |
| GE2 | DI water | 13.4 | 1.8 | N/A | 1.85E−03 | 1.50 |
| GE9 | DI water | 0 | 2 | | 4.32E−04 | 1.59 |
| GF8 | DI water | 0.5 | 2 | N/A | 1.03E−03 | 1.49 |
| GE7 | DB71 | 5.3 | 1.8 | 53.79% ± | 9.59E−04 | 2.27 |
| | | | | 3.98% | | |
| GE11 | DB71 | 74.2 | 1.8 | 14.75% ± | 1.88E−03 | 1.73 |
| | | | | 0.74% | | |
| GD2 | DB71 | 0 | 2 | | 1.06E−04 | 2.52 |
| GF2 | DB71 | broke | 0 | | 1.11E−03 | 1.47 |
| GF4 | DB71 | 0.9 | 2 | 99.26% ± | 4.18E−04 | 1.97 |
| | | | | 7.14% | | |
| GF7 | DB71 | 0 | 2.1 | | 3.11E−04 | 1.73 |
| GF6 | DB71 | 0 | 2.1 | | 1.07E−04 | 2.40 |
| GE4 (2) | DB71 | 0 | 2.1 | | 3.49E−05 | 1.56 |
| FP2 (3) | DB71 | 0 | 2.1 | | 5.04E−04 | |
| GE12 | 5 nm Au | 0 | 2 | | 1.07E−04 | 2.21 |
| GE3 | 5 nm Au | broke | 2 | | 6.66E−04 | 1.37 |
| GE8 | 5 nm Au | 0 | 2 | | 9.42E−04 | 1.25 |
| GF8 (2) | 5 nm Au | 0 | 2 | | 1.03E−03 | 1.49 |
| FN6 | 5 nm Au | 0 | 1.6 | | 1.32E−03 | 1.69 |
| FR1 | 5 nm Au | broke | 1.6 | | 1.65E−04 | |
| FP2 (2) | 5 nm Au | 0 | 1.6 | | 7.87E−05 | 2.52 |
| FO10 | 5 nm Au | 0 | 2 | | 2.05E−04 | 2.75 |
| GE4 | 5 nm Au | 0 | 2 | | 5.72E−05 | 2.40 |
| FR5 | 5 nm Au | broke | 1.6 | | 1.83E−04 | 1.24 |
| FR9 | 5 nm Au | 0 | 2 | | 1.26E−05 | 1.72 |
| FO9 (2) | 5 nm Au | broke | 1.9 | | 6.05E−04 | 0.41 |
| FO7 (2) | 5 nm Au | broke | 1.9 | | 2.53E−04 | 1.30 |
| FQ7 | 5 nm Au | 0 | 1.9 | | 9.59E−04 | 1.60 |
| FP9 | 5 nm Au | 52.1 | 1.9 | 7.35% ± | 1.88E−03 | 1.74 |
| | | | | 0.40% | | |
| FO5 | 15 nm Au | 0 | 2 | | 2.93E−06 | |
| FP2 | 15 nm Au | 0 | 2 | | 7.87E−05 | 2.52 |
| FP10 | 15 nm Au | 0 | 2 | | 4.39E−04 | 2.14 |
| FR8 | 15 nm Au | 0 | 2 | | 3.70E−04 | 1.92 |
| FO7 | 15 nm Au | 13.7 | 2 | 95.40% ± | 8.55E−03 | 1.68 |
| | | | | 0.11% | | |
| FO9 | 15 nm Au | 3 | 2 | 98.38% ± | 1.36E−03 | 1.48 |
| | | | | 0.30% | | |
| FO8 | 15 nm Au | 1.3 | 2 | 99.27% ± | 1.99E−04 | 2.56 |
| | | | | 0.97% | | |
| FQ8 | 15 nm Au | 0 | 2 | | 8.78E−04 | 1.61 |
| FQ3 | 15 nm Au | 0 | 2 | | | |
| FQ5 | 15 nm Au | 0 | 2 | | | |
| FR4 | 15 nm Au | 61.4 | 2 | | | |
| FB8 | 15 nm Au | 0 | 1.1 | | | |
| FC1 | 15 nm Au | 0 | 1.1 | | | |
| EX3 | 15 nm Au | 0 | 1.1 | | | |
| FB2 | 15 nm Au | 0 | 1.1 | | | |

### Example 4: Advancements in Two-Step Methods of Forming VACNT Membranes

As shown in Example 2, a novel solvent-phase deposition technique (FIGS. 4A-4C) was demonstrated and it was possible to increase deposited MWNT number density by 7 times over previous methods. This increase in number density can be attributed in certain non-limiting embodiments to the enhanced solubility of CNTs in CHP. However, sometimes during the polymer infiltration step, MWNTs appeared to be “wiped off” of a portion of the deposited area, resulting in a highly non-uniform CNT concentration, as shown in FIGS. 12A-12D. The CNTs were wiped off the electrode surface during infiltration as the solvent flowed past CNTs, even before the more viscous polymer reached the CNTs. A simple calculation of the viscous shear forces shows that it is not feasible to retain the CNTs by simply decreasing the infiltration rate. If one were to decrease the infiltration rate so that the shear forces occurring in the polymer drop below the currently occurring shear forces in CHP, the infiltration duration would be prolonged to well over a day, due to the much higher viscosity of the polymer as compared to CHP. Thus, another solution is needed to prevent the removal of deposited CHPs and reliably increase the CNT number density achievable by the solvent-deposition method.

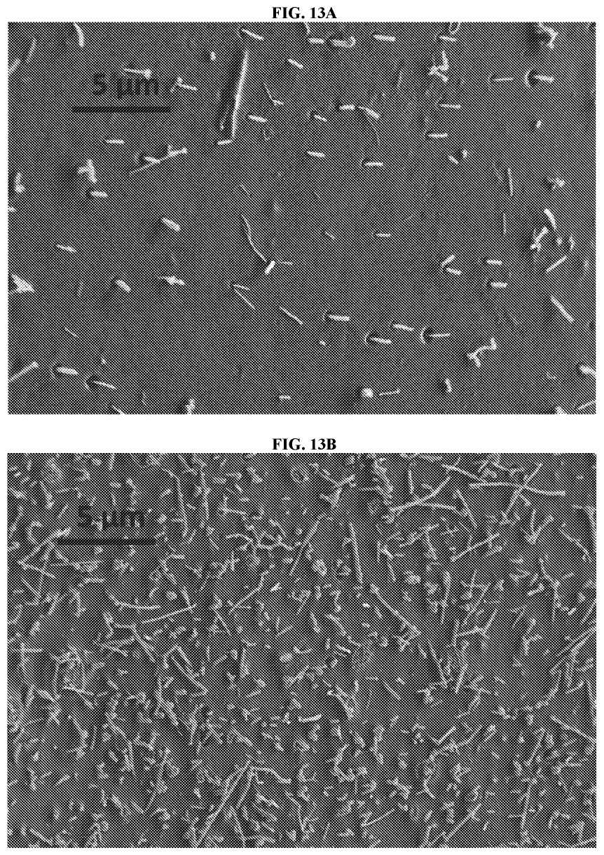

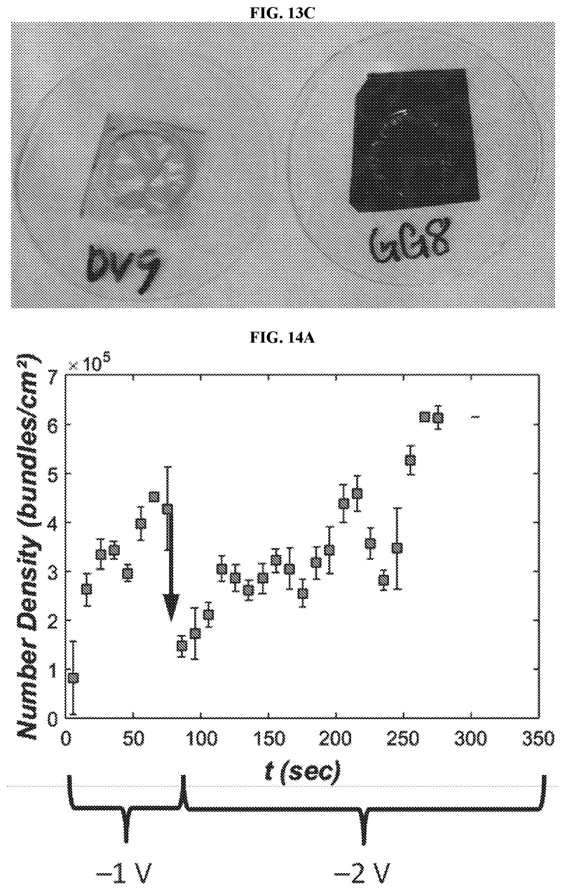

It was hypothesized that CHP contamination may have been responsible for the observed removal of the aligned and deposited nanotubes during the infiltration step (the CHP had been previously reused as a solvent during centrifugation to remove excessively short or long nanotubes). Repeating the electrodeposition and subsequent polymer infiltration with pristine CHP, the CNTs were retained on the electrode surface, as seen in FIG. 12D. Ethanol may have contaminated the CHP during centrifugation, perhaps as a residual from cleaning of the vials or filtration glassware. If this ethanol contamination increased the electrical conductivity of the CHP, then the electrical double layer formed during electrodeposition would be expected to be thinner and could more effectively screen the E-field, hindering CNTs from closely approaching the electrode. This would result in CNTs that are weakly bound to the electrode and could be easily wiped off by the infiltrating CHP or polymer. When fresh CHP is used for the solvent-deposition process, the process became much more repeatable, and the number density of aligned and deposited CNTs was increased to 9×10⁷ CNTs/cm². The nanotube density was also more uniform across the membrane surface, as is evident from the SEM images seen in FIGS. 13A-13B.

Although the solvent-deposition process was demonstrated using MWNTs, which may have internal blockages that would prevent high flow rates, etching and testing of membranes with higher MWNT number densities than ever achieved before were initiated. The cured film was subdivided and eight 8-mm diameter membranes were mounted for flow testing. Of these, only one of the membranes, CG4, was found to be initially without defects.

Table 3 shows the results of the flow tests, illustrating the He—N₂ flowrate ratios, each only 1.52 or below. Based on these flowrate ratios, seven of the membranes have defects larger than a micron. The N₂ flowrate for membrane GG4 was below the instrument measurement limit, so the He flowrate was not obtained (likewise for the He—N₂ flowrate ratio) but it was concluded that this membrane did not have defects. The membrane yield, 12.5%, is well below the yield for previous membranes fabricated with direct alignment and deposition from the polymer, which typically has yields of 75-80%. However, this lower yield is consistent with a first-order estimation of the expected yield assuming defects come from CNT aggregates in the CNT suspension. Considering one has 9 times as many CNTs in the highly concentrated membranes, the yield can be estimated as (80%)=13%. Thus, it is likely that the larger number of defects in these membranes is due to the higher number of CNT agglomerates in the original solutions. This may be alleviated with more complete removal of CNT aggregates, e.g., example by more intense centrifugation of the CNT suspension, before membrane fabrication. Nevertheless, the maximum MWNT number density was increased by 9 times over that achievable with solution-based, electric-field-assisted VACNT membrane fabrication.

TABLE 3
Flow testing results for MWNT membranes fabricated
with the solvent-phase deposition technique.

| Membrane | N₂ Permeance (cc/kPa min) | Q_{He}/Q_{N2} |
|---|---|---|
| GG1 | 3.90E+01 | 0.98 |
| GG2 | 5.46E−04 | 1.49 |
| GG3 | 6.38E+00 | 1.02 |
| GG4 | Below measurement limit | N/A |
| GG5 | 3.36E−03 | 1.52 |
| GG6 | 6.06E−04 | 1.38 |
| GG7 | 1.15E−01 | 0.97 |
| GG8 | 1.10E+01 | 1.02E+01 |

### Example 5: Formation of VACNT Membranes Comprising Bundled Nanotubes Through a Two-Step Method

Examples 2 and 4 demonstrated a solvent-phase deposition technique which allowed for an increase the CNT density of Sigma-Aldrich (SA) MWNTs by a factor of 10. These techniques were applied to SWNT bundles, as described in Examples 1 and 3, and a factor of 3 increase in the deposited number density was achieved. To maximize the deposited SWNT-bundle number density, electrodeposition experiments was first performed under the optical microscope to optimize the electric-field parameters. In these tests, EDA-treated SWNTs from a 1 cm² wafer were bath sonicated for 5 sec in CHP to release SWNT bundles and form a nanotube suspension. The SWNT suspension was placed between two ITO slides and observed on the optical microscope as a prescribed E-field was applied. From recorded images of the alignment and deposition of SWNT bundles on the ITO electrodes, the number density of nanotubes was measured as a function of time.

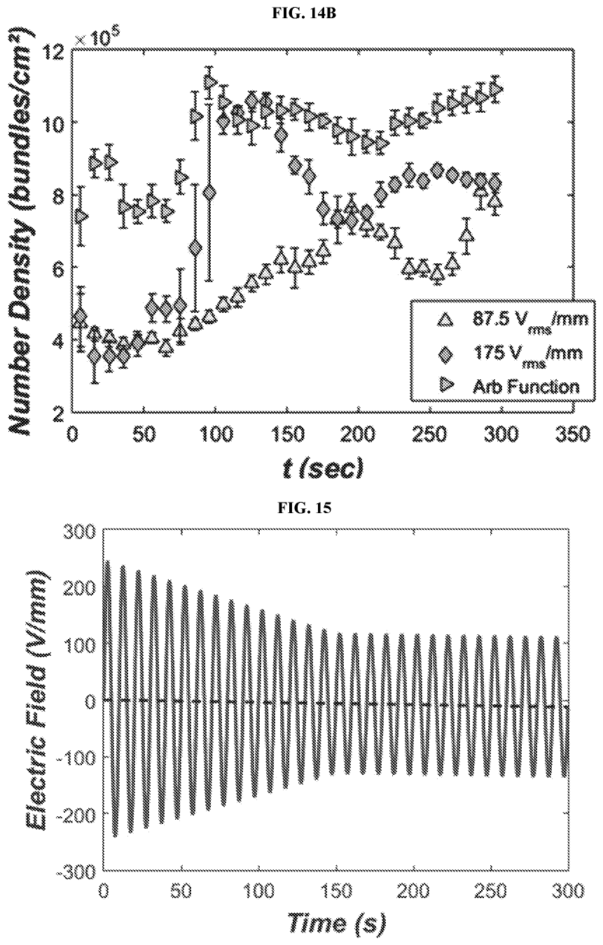

Initially, parameters similar to the E-field used previously to deposit SA MWNTs in CHP were tested. The resulting number density of aligned and deposited SWNT bundles can be seen in FIG. 14A. This E-field, which employs a stepped increase in the DC voltage, was seen to gather SWNT bundles on the electrode surface initially, but then the bundles were lost as the DC voltage was stepped from −1 V to −2 V. This is likely due to increased electroconvective motion of the CHP as ions in a charged electrical double layer are acted on by the DC field. When the DC voltage is changed abruptly, flow instabilities become significant and can wash deposited bundles off the electrode surface. This may have been less significant with the SA MWNTs whose larger diameter and different tip structure may result in stronger adhesion to the electrode. To mitigate these undesirable effects, the E-field profile was changed to ramp up the DC voltage gradually, instead of utilizing a step change in the offset. Electric field alignment and deposition was tested using AC voltages of 87.5 Vᵣₘₛ/mm and 175 Vᵣₘₛ/mm and DC voltages that ramped up (in magnitude) from 0 to −2.5 V over 5 minutes. As shown in FIG. 14B, when 87.5 Vᵣₘₛ/mm was applied, a gradual increase in the CNT number density was seen as a function of time. However when 175 Vᵣₘₛ/mm was applied, more rapid initial rise and a higher maximum number density were seen, followed by a reduction in the SWNT number density around 150 s into the deposition. Without wishing to be limited by any theory, this drop is believed to occur when both the AC and DC field strengths are high; while the high DC field charges a double layer on the electrodes, the high AC field may perturb the charged layer, causing fluid motion which washes away deposited CNTs. When the lower AC field of 87.5 Vᵣₘₛ/mm is applied, the SWNTs do not seem to be washed away as much even as the DC voltage reaches −2.5 V_{DC}.

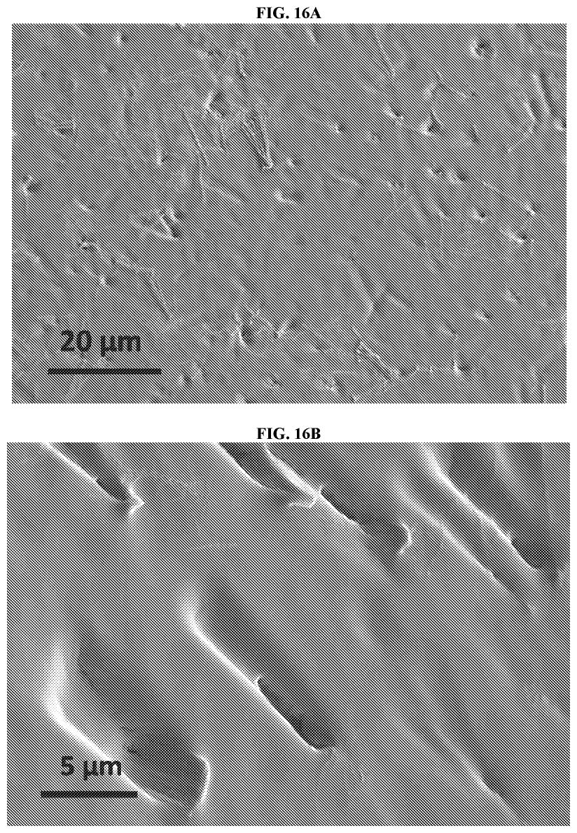

For an optimized electric field that rapidly captures the CNTs (as shown in FIG. 14B for AC fields of 175 Vᵣₘₛ/mm) but also retains them over time (as seen for the AC field of 87.5 Vᵣₘₛ/mm), an electric field was proposed that is initially high in AC-field strength but ramps down as the DC field slowly increases in strength. The proposed function can be seen explicitly in Equation 1 and is graphed in FIG. 15. As seen in FIG. 14B, this optimized electric field is capable of depositing the CNTs and maintaining the deposited number density for the entire duration of deposition. The number density seen graphed in FIGS. 14A and 14B is measured by an image-processing algorithm, which has been observed to report lower number densities than SEM imaging. Therefore observations and conclusions were made on the relative trends in the data of FIGS. 14A-14B, instead of the absolute number density.

Having established E-field parameters that are optimized to deposit a high number density of SWNT bundles in CHP, CHP with SWNT bundles was then pumped into an ITO-electrode microfluidic system, the bundles were aligned and deposited, and then polymer was infiltrated into the deposited CNT forest, before finally a thin membrane was laser cured (as described in Examples 2 and 4 and FIGS. 4A-4C). The membrane, seen in FIGS. 16A-16B, has 1.6×10⁶ bundles/cm² and is 3.2 μm thick, on average. Despite the high nanotube number density (approximately 3 times higher) and the thinness of these membranes (as compared to the typical 4.5 μm thickness of typical polymer-deposited membranes), 4 of the 6 smaller-diameter mounted membranes were initially defect-free. In preliminary etching studies, one membrane showed no flow after 2×3 min of O₂-plasma at 100 W while another opened up with a He—N₂ flowrate ratio of 1.70, indicating defects on the ˜100 nm scale.

### Example 6: Spin Coated Membranes

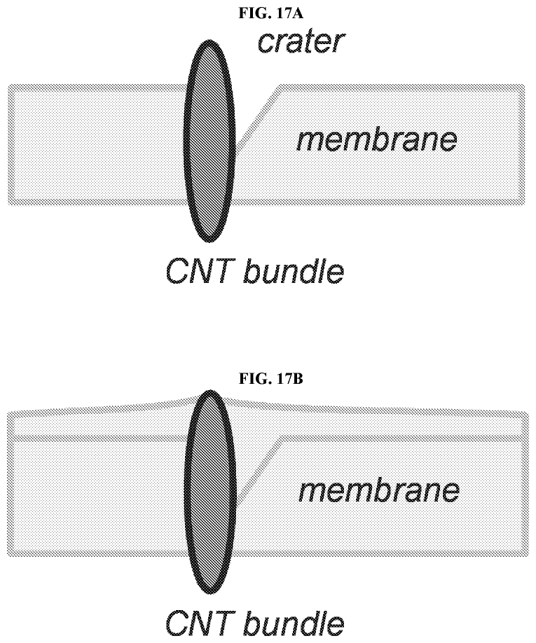

In order to increase membrane yield, new membrane fabrication methods were explored. The membranes were strengthened by spin-coating a thin layer of polymer onto the membrane after laser curing, as seen in FIGS. 17A-17B. The spin coating preferentially fills in craters around CNT bundles; such craters, which are caused by CNT-bundle-generated shadows in the UV light during curing, are believed to be a major source of defects in the membranes, particularly under etching to open nanotube pores. The spin coating can also significantly strengthen the thin membranes cured with the solvent-phase deposition approach. As previously noted, these solvent-deposited membranes are approximately 1 μm thinner than the typical polymer-deposited membranes.

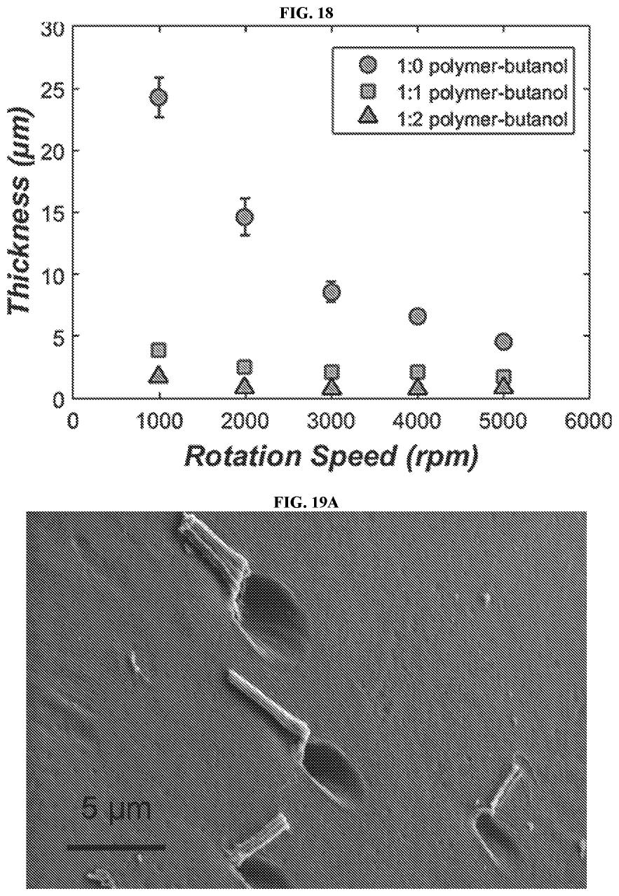

To fill in craters in the membrane without increasing the membrane thickness too much, a well-controlled, uniform layer approximately 1 μm in thickness is desirable. However, because of their high viscosity, the oligomer solutions did not spin down to 1 μm. For this reason, a non-volatile thinning agent that could later be removed was added to the solution. Butanol was chosen due to its miscibility in the oligomer system and because it does not evaporate during the room-temperature spin-coating procedure. After spin coating, the coated membrane was baked at 150° C. for 3 min to eliminate the butanol and prevent the formation of voids in the coating. Because of this heating step, benzophenone was used as the photoinitiator, as Darocur 1173 can also evaporate at this temperature. Systematic optimization was conducted to determine the rotation speeds and percentage of butanol needed to achieve the desired spin-coating thickness. As seen in FIG. 18, highly uniform spin-coated layers of thicknesses down to below 1 μm were achieved when the polymer was mixed 1:2 (vol.) with butanol. This technique was applied to a solvent-phase-deposited SWNT-bundle membrane and the total thickness of the membrane was increased to 5.0 μm.

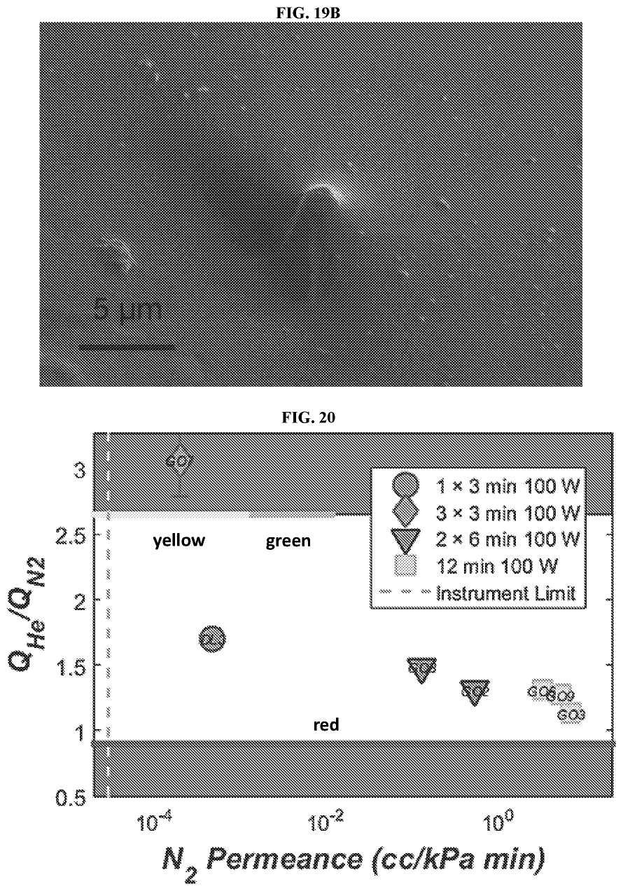

The spin-coating technique was also applied to strengthen polymer-phase-deposited membranes. Comparison of membranes imaged with and without spin coating showed that deep craters near the SWNT bundles are eliminated by the spin coating, as seen in FIG. 19B, while the bundles themselves remained visible. When these spin-coated membranes were subdivided into 21 smaller, 8 mm diameter membranes for flow testing, not a single membrane was found to have a defect before etching. Prior to this, membranes yields were typically 75-90%, so the spin-coating technique appears to be helping to reduce defects in the membrane. When these membranes were treated with O₂ plasma to etch the CNT caps open, the membranes also seemed to withstand stronger etching without the generation of defects. Membranes treated with an additional spin-coated layer survived 6 min of O₂-plasma without introducing defects, and one membrane presented a high He—N₂ flowrate ratio after 3×3 min of O₂-plasma etching, seen in FIG. 20.

### Example 7: Flow Testing of SWNT-Bundle Membranes

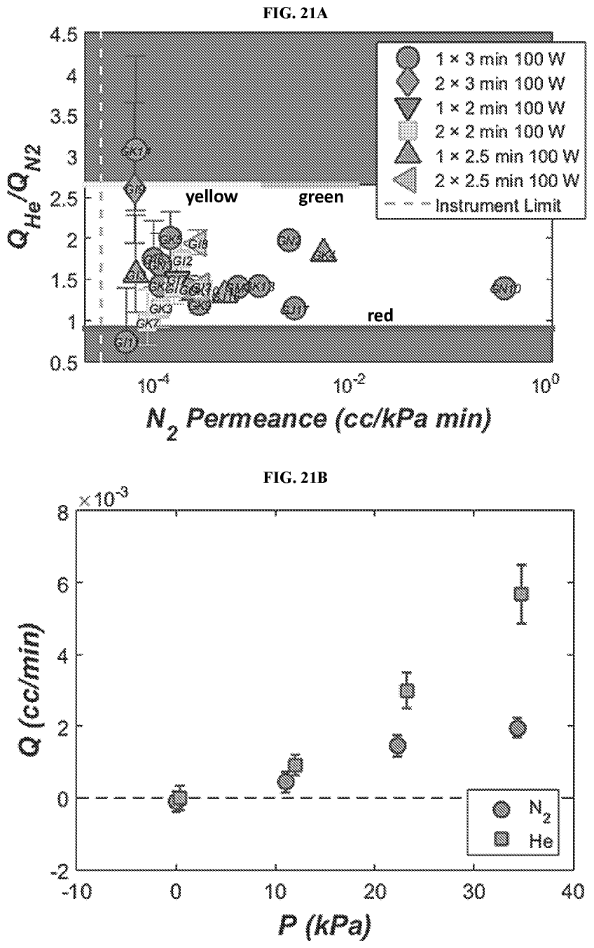

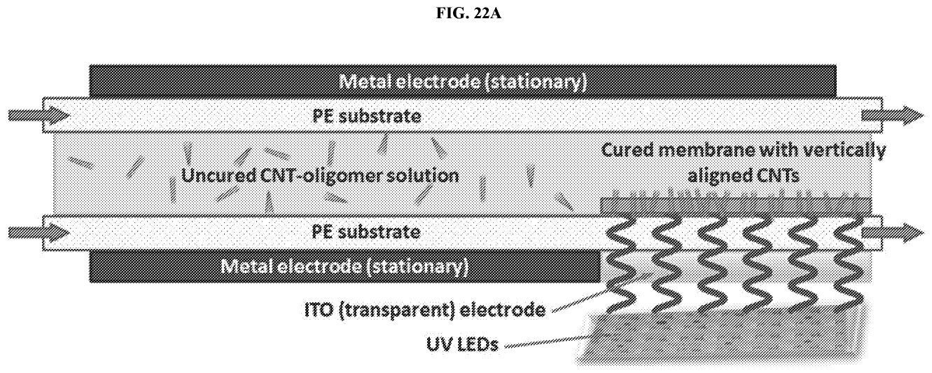

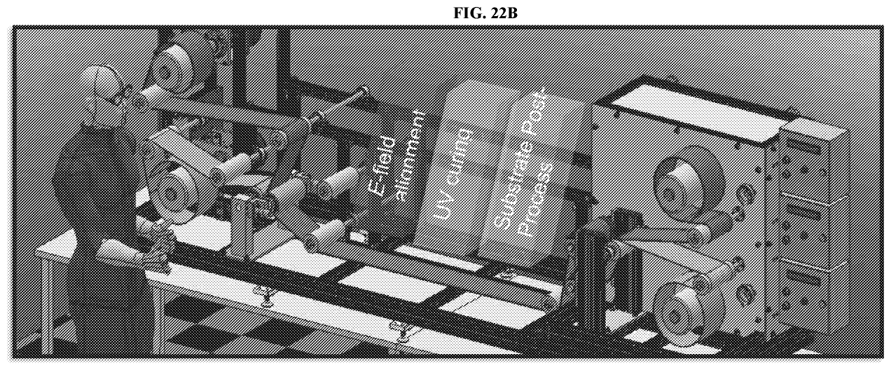

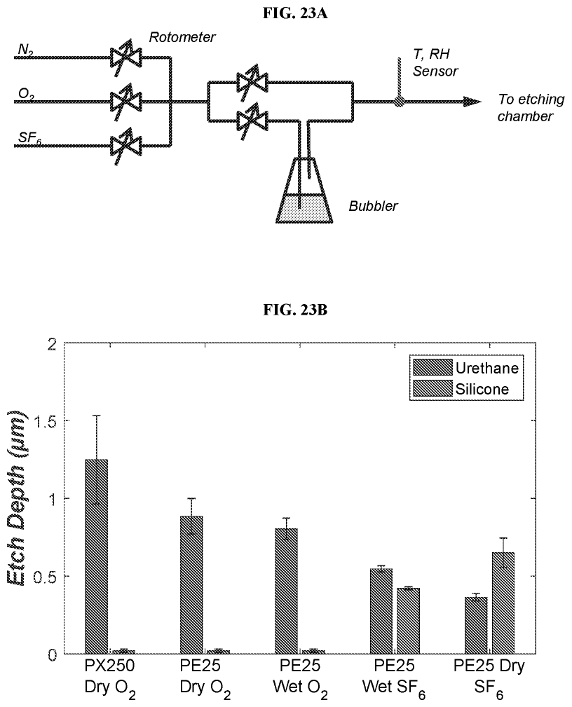

SWNT-bundle membranes as reported in Examples 1 and 3 were tested for He—N₂ flowrate ratios, as shown in FIG. 21A. In this graph, only two membranes have the high He—N₂ flowrate ratios that would be expected from SWNT pores: one treated with 3 min O₂-plasma and the other etched with 2×3 min O₂-plasma. To confirm these He—N₂ flowrate measurements, detailed flowrates were further measured for both gases using three values of applied pressure, as seen in FIG. 21B. The linear curves pass through the origin, showing the accuracy of the measurement and increasing confidence that the membranes do indeed have the high He—N₂ flowrate ratios indicative of nanoscale pores. Additionally, control membranes (without SWNTs) were etched alongside each SWNT membrane, and found to be not open. This indicates that the CNTs in the membrane are in some way causing the observed flow.

### Example 8: Scalable Membrane Manufacturing Methods

The membranes and methods of the invention can be adapted for large scale production as outlined in FIGS. 22A-22B. For example, roll-to-roll coating apparatuses currently in use for the production of hybrid polymers can be adapted for the manufacture of the presently described membranes.

In one non-limiting embodiment according to FIGS. 22A-22B, a membrane of the invention can be produced by moving an uncured polymer precursor solution comprising CNTs between a set of stationary electrodes. As the polymer precursor solution moves along the electrodes, the CNTs align themselves. At a point along the path, the polymer precursor comprising the aligned CNTs can be photocured, forming the polymer membrane. In certain embodiments, the polymer membrane can be photocured through the use of a wide-area LED array which emits collimated light. Further along, the membrane can undergo post-processing where the membrane is etched to expose the aligned CNTs. In certain embodiments, a substrate, such as poly ethylene can be used as a buffer between the electrodes and the polymer precursor.

In certain embodiments, the large scale production can be performed on a single machine designed to continuously manufacture a polymer membrane of the invention. In other embodiments, the large scale production can be performed by a series of specialized machines which are optimized to carry out one or more steps of the methods of the invention.

### Example 9: Multiplayer Membranes

The methods of the invention can be performed so that a multiplayer membrane can be obtained. In that case, a first layer is deposited with electric-field aligned nanotubes on a solid support according to certain embodiments described elsewhere herein Subsequently, another layer is deposited on the exposed surface of the first layer according to certain embodiments described elsewhere herein. The process is repeated until a membrane of required thickness and/or strength is obtained. The multilayer membrane with vertically aligned nanotubes is then removed from the solid support and submitted to an etching process until the desired permeability is obtained. In certain embodiments, etching takes place once the multilayer membrane is formed. In other embodiments, etching can take place after one intermediate layer of the multilayer membrane is formed. In yet other embodiments, etching can take place after one or more intermediate layers of the multilayer membrane is formed. In yet other embodiments, etching can take place after each intermediate layer of the multilayer membrane is formed.

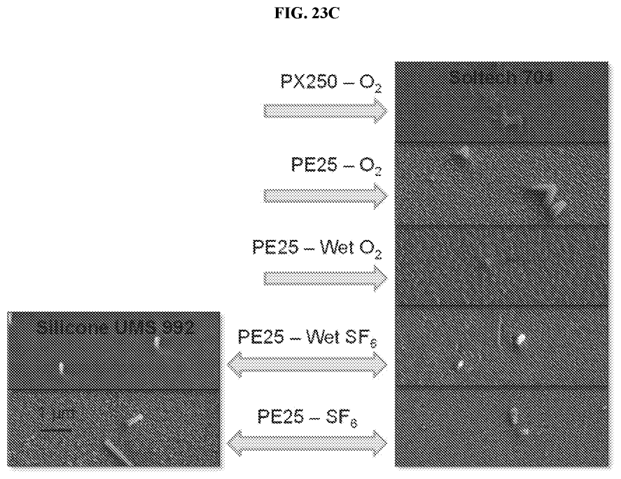

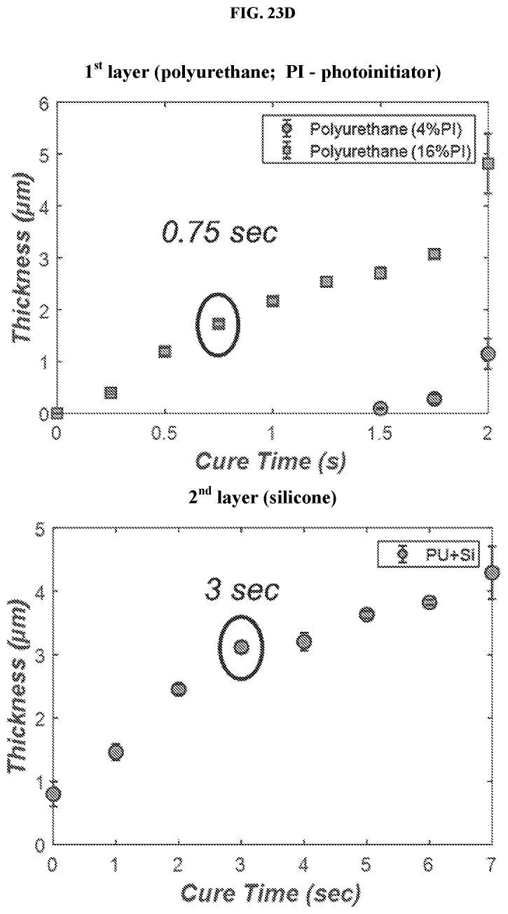

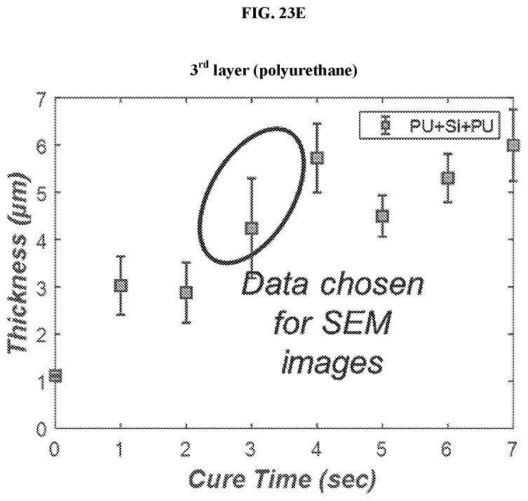

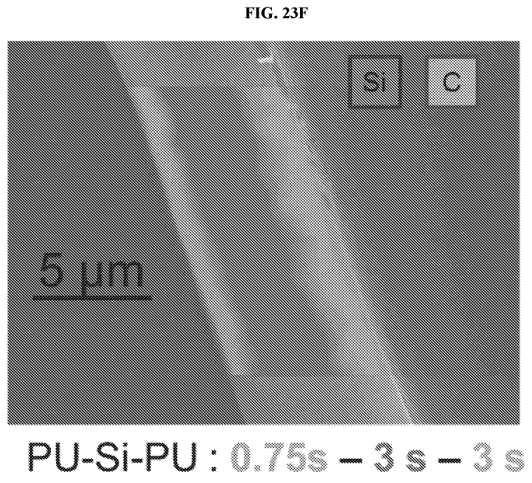

As a non-limiting example, a tri-layer membrane was prepared using a silicon-polyurethane-silicone set-up (FIGS. 23A-23F). In that particular case, silicone was effectively etched using SF₆/N₂/O₂/H₂O plasma; SF₆, O₂, and H₂O vapor are mixed and injected into the chamber (see FIG. 23A). FIG. 23B illustrates experimental etching rates for the polymers using various etching conditions. PX250 (or PX-250) corresponds to March Instruments PX-250 Plasma Etch System (Via Pacinotti 5 Zona Ind., 81020 San Nicola La Strada (CE), Italy), and PE25 (or PX-25) corresponds to PE-25 Low Cost Plasma Cleaner (3522 Arrowhead Drive, Carson City, Nev., 89706 USA). In non-limiting embodiments, when etching urethane, PE25 wet O₂ and PX250 dry O₂ appear to provide the best surface quality. In non-limiting embodiments, when etching silicone, PE25 wet SF6 appears to have best surface quality. Without wishing to be limited by any theory, wet SF₆ adds O* radicals, creating SiO₂ off the silicone layer. See FIG. 23C.

The correlation of thickness vs. cure time for each layer of the trilayer membrane is illustrated in FIGS. 23D-23E. For the first layer (polyurethane with varying % of photoinitiator), a cure time of 0.75 sec allowed for a membrane thickness of about 2 μm. For the second layer (silicine), a cure time of 3 sec allowed for a total thickness of about 3 μm. For the first layer (polyurethane with 16% of photoinitiator), a cure time of 3-4 sec allowed for a total membrane thickness of about 5 μm. The EDX analysis of the trilayer membrane is provided in FIG. 23F. The disclosures of each and every patent, patent application, and publication cited herein are hereby incorporated herein by reference in their entirety. While this invention has been disclosed with reference to specific embodiments, it is apparent that other embodiments and variations of this invention may be devised by others skilled in the art without departing from the true spirit and scope of the invention. The appended claims are intended to be construed to include all such embodiments and equivalent variations.

1. (canceled)

2. A method of fabricating a porous polymer membrane, the method comprising:
(a) contacting a first solution suspension, comprising nanotubes suspended therein, with a substrate surface;
(b) electrodepositing the nanotube bundles onto the substrate surface, such that the nanotube bundles are aligned perpendicular to the substrate surface;
(c) optionally flowing a second solution not comprising suspended nanotubes over the substrate surface in order to remove any nanotubes that have not been electrodeposited onto the substrate surface;
(d) flowing a polymer precursor over the substrate surface, displacing any solution in contact with the aligned nanotube bundles;
(e) curing the polymer precursor thereby, forming a polymer membrane comprising embedded nanotubes;
(f) optionally repeating steps (a)-(e) at least one time, so as to generate a multilayer polymer membrane, wherein the nanotubes and polymer precursor suspension used in each repetition are independently selected;
(g) removing the polymer membrane from the substrate and etching the polymer membrane surface(s) to expose the embedded carbon nanotubes,
wherein the nanotubes or nanotube bundles optionally comprise one of
i) carbon nanotubes;
ii) single walled nanotubes, double wall nanotubes, or mixtures thereof;
iii) uncapped nanotubes, having an at least partially unblocked lumen throughout the length of each nanotube; or
iv) nanotubes functionalized with at least one functional group that promotes bundling.

3. A method of fabricating a porous polymer membrane, the method comprising:
(a) contacting a polymer precursor suspension, comprising nanotube bundles suspended therein, with a substrate surface, wherein the substrate is transparent to at least one wavelength of light from a light source;
(b) electrodepositing the nanotube bundles onto the substrate surface, such that the nanotube bundles are aligned perpendicular to the substrate surface;
(c) photocuring the polymer precursor suspension by exposing the polymer precursor to the light source through the transparent electrode, such that the polymer precursor suspension is selectively cured up to the extinction length of the light source wavelength within the polymer precursor medium, thereby forming a polymer membrane comprising embedded nanotubes;
(d) optionally repeating steps (a)-(c) at least one time, so as to generate a multilayer polymer membrane, wherein the nanotube bundles and polymer precursor suspension used in each repetition are independently selected;
(e) removing the polymer membrane from the substrate and etching the polymer membrane surface(s) to expose the ends of the embedded nanotubes,
wherein the nanotubes or nanotube bundles optionally comprise one of
i) carbon nanotubes;
ii) single walled nanotubes, double wall nanotubes, or mixtures thereof;
iii) uncapped nanotubes, having an at least partially unblocked lumen throughout the length of each nanotube; or
iv) nanotubes functionalized with at least one functional group that promotes bundling.

4-7. (canceled)

8. The method of claim 2, wherein the nanotube bundles comprise nanotubes functionalized with at least one functional group selected from the group consisting of amine, alkyl amine, carboxyl, phenolic, lactone, and hydroxyl.

9. The method of claim 2, wherein the nanotubes or nanotube bundles have one of:
i) a length of about 1 μm to about 200 μm;
ii) a length of about 5 μm to about 15 μm; or
iii) a diameter of about 0.5 nm to about 150 nm.

10. (canceled)

11. (canceled)

12. The method of claim 2, wherein the polymer precursor comprises at least one monomer selected from the group consisting of aromatic urethanes, aliphatic urethanes, urethane acrylates, silicones, and multifunctional aromatic compounds.

13. The method of claim 2, wherein the polymer precursor comprises at least one polymerization initiator.

14. The method of claim 2, wherein the substrate is an electrode that comprises at least one material selected from the group consisting of metals, metal oxides, and conductive polymers.

15. (canceled)

16. The method of claim 14, wherein at least a portion of the electrode comprises a material transparent to at least one wavelengths in the ultraviolet light (10-400 nm), visible light (400-750 nm), and/or infrared light (750 nm-2,000 nm) ranges.

17. The method of claim 2, wherein the substrate is a material layer disposed on the surface of an electrode such that the nanotubes or nanotube bundles electrodeposit on the substrate surface distal to the electrode; and
wherein the substrate comprises at least one material selected from the group consisting of polyethylene, silicone, cyclic olefin polymer, and polymethyl methacrylate.

18. The method of claim 17, wherein the substrate comprises a material transparent to at least one wavelength in the ultraviolet light (10-400 nm), visible light (400-750 nm), and/or infrared light (750 nm-2,000 nm) ranges.

19-25. (canceled)

26. The method of claim 2, wherein the polymer precursor is cured through photocuring.

27-30. (canceled)

31. The method of claim 2, wherein the electrode comprises a transparent material and wherein the polymer precursor suspension is selectively cured through exposure to a light source through the substrate, wherein the polymer precursor is cured only up to the extinction length of the light source wavelength within the polymer precursor medium.

32. The method of claim 2, wherein the polymer precursor is heat cured and/or chemically cured.

33. The method of claim 2, wherein the polymer membrane is etched through the use of reactive-ion etching.

34. (canceled)

35. (canceled)

36. The method of claim 2, wherein the polymer membrane is etched through electrochemical etching.

37-39. (canceled)

40. The method of claim 2, wherein the nanotubes are at least partially agglomerated in nanotube bundles.

41. The method of claim 2, wherein at least one from the group consisting of the first solution and the second solution comprises an organic solvent.

42. The method of claim 2, wherein the first and second solutions comprise solvents that do not dissolve carbon nanotubes and/or do not decay carbon nanotubes.

43. The method of claim 2, wherein the first and second solution each comprises at least one solvent independently selected from the group consisting of 1-cyclohexyl-2-pyrrolidinone, acetone, dichloromethane, ethanol, isopropanol, hexanes, dichloroethane, dichlorobenzene and dimethylformamide.

44. A porous polymer membrane,
wherein the membrane comprises at least one layer,
wherein the membrane comprises embedded aligned carbon nanotubes in at least one layer of the membrane,
wherein the aligned carbon nanotubes, each having an unobstructed lumen, extend through the polymer membrane layer in which they are contained, such that the lumen of the aligned carbon nanotubes define a pore extending through the polymer membrane layer.

45. A porous polymer membrane fabricated by the method of claim 2.
